(19) United States
(12) Patent Application Publication
(10) Pub. No.: US 2018/0039621 A1
(43) Pub. Date: Feb. 8, 2018

(54) CONTEXT ANALYSIS FOR MESSAGE ENHANCEMENT

(71) Applicant: Monotype Imaging Inc., Woburn, MA (US)

(72) Inventors: Evan Scronce, Lindenhurst, IL (US); Neeraj Gulati, Haryana (IN); Anand Vijay, Pradesh (IN); Sohaj Singh Brar, Punjab (IN); Ashutosh Singh Rawat, Noida (IN); Prasun Raj Moolambally, Pradesh (IN)

(21) Appl. No.: 15/669,660

(22) Filed: Aug. 4, 2017

Related U.S. Application Data
(60) Provisional application No. 62/371,484, filed on Aug. 5, 2016.

(51) Int. Cl. G06F 17/27; G06F 3/0481

(52) U.S. Cl. CPC G06F 17/2785; G06F 3/04817

(57) ABSTRACT

A system includes a computing device that includes a memory configured to store instructions. The system also includes a processor to execute the instructions to perform operations that include receiving data representing textual information input into a user device. Operations also include analyzing the data to determine the contextual meaning of the textual information, and producing one or more messages to present information at one or more other user devices using the contextual meaning of the textual information.

### CLAIM OF PRIORITY

This application claims benefit of priority under 35 U.S.C. § 119(e) to U.S. Provisional Patent Application Ser. No. 62/371,484 filed on Aug. 5, 2016, the entire contents of which are hereby incorporated by reference.

### BACKGROUND

This description relates to exploiting the context of text messages for creating enhancements for the same or other messages. Along with determining the particular contexts of a message, content associated with the context can be identified and used in message creation.

Over the past years, text messaging has continued to evolve towards becoming the preferred manner of communicating, in particular among the younger segment of our society. Similar to younger users, older individuals are becoming more comfortable with using text messaging services and capable to addressing the ever increasing rate of text message delivery. With this ever increasing growth in the usage of this technology, more and more potential consumers are using text messaging services in professional aspects of their lives along with their personal lives.

### SUMMARY

The systems and techniques described herein can aid in efficiently creating messages such as text messages. By gleaming the context of a message (or messages) associated with a user, group, etc., additional content such as polling questions, surveys, etc. can be developed and integrated into messages without substantial user input. Along with user input (e.g., entered text), various other information sources may be employed to integrating additional content. Historical data, feedback from other users, etc. may be used along with predefined templates, etc. Information associated with services, products, brands, etc. may also be identified and used to supplement a message and further provide helpful information to message recipients while reducing the needed time and efforts from the message creator.

In one aspect, a computing device implemented method includes receiving data representing textual information input into a user device. The method also includes analyzing the data to determine the contextual meaning of the textual information, and producing one or more messages to present information at one or more other user devices using the contextual meaning of the textual information.

Implementations may include one or more of the following features. Analyzing the data to determine the contextual meaning of the textual information may include determining one or more input requesting queries for including in the one or more messages. The input requesting queries may include one or more poll questions. The produced one or more messages may present the poll questions in a nested manner. The method may further include receiving feedback information from the one or more other user devices in response to the input requesting queries. Analyzing the data to determine the contextual meaning of the textual information may include using historical data associated with producing previous messages. Analyzing the data to determine the contextual meaning of the textual information may include performing a natural language processing. Producing one or more messages to present information at one or more other user devices using the contextual meaning of the textual information may include identifying one or more graphics for including in the one or more messages. Producing one or more messages to present information at one or more other user devices using the contextual meaning of the textual information may include identifying links for including in the one or more messages. Analyzing the data to determine the contextual meaning of the textual information may include identifying information that complements the contextual meaning of the textual information. Complementary information may include event related information. Complementary information includes graphics associated with the contextual meaning of the textual information.

In another aspect, a system includes a computing device that includes a memory configured to store instructions. The system also includes a processor to execute the instructions to perform operations that include receiving data representing textual information input into a user device. Operations also include analyzing the data to determine the contextual meaning of the textual information, and producing one or more messages to present information at one or more other user devices using the contextual meaning of the textual information.

Implementations may include one or more of the following features. Analyzing the data to determine the contextual meaning of the textual information may include determining one or more input requesting queries for including in the one or more messages. The input requesting queries may include one or more poll questions. The produced one or more messages may present the poll questions in a nested manner. Operations may further include receiving feedback information from the one or more other user devices in response to the input requesting queries. Analyzing the data to determine the contextual meaning of the textual information may include using historical data associated with producing previous messages. Analyzing the data to determine the contextual meaning of the textual information may include performing a natural language processing. Producing one or more messages to present information at one or more other user devices using the contextual meaning of the textual information may include identifying one or more graphics for including in the one or more messages. Producing one or more messages to present information at one or more other user devices using the contextual meaning of the textual information may include identifying links for including in the one or more messages. Analyzing the data to determine the contextual meaning of the textual information may include identifying information that complements the contextual meaning of the textual information. Complementary information may include event related information. Complementary information includes graphics associated with the contextual meaning of the textual information.

In another aspect, one or more computer readable media storing instructions that are executable by a processing device, and upon such execution cause the processing device to perform operations that include receiving data representing textual information input into a user device. Operations also include analyzing the data to determine the contextual meaning of the textual information, and producing one or more messages to present information at one or more other user devices using the contextual meaning of the textual information.

Implementations may include one or more of the following features. Analyzing the data to determine the contextual meaning of the textual information may include determining one or more input requesting queries for including in the one or more messages. The input requesting queries may include one or more poll questions. The produced one or more messages may present the poll questions in a nested manner. Operations may further include receiving feedback information from the one or more other user devices in response to the input requesting queries. Analyzing the data to determine the contextual meaning of the textual information may include using historical data associated with producing previous messages. Analyzing the data to determine the contextual meaning of the textual information may include performing a natural language processing. Producing one or more messages to present information at one or more other user devices using the contextual meaning of the textual information may include identifying one or more graphics for including in the one or more messages. Producing one or more messages to present information at one or more other user devices using the contextual meaning of the textual information may include identifying links for including in the one or more messages. Analyzing the data to determine the contextual meaning of the textual information may include identifying information that complements the contextual meaning of the textual information. Complementary information may include event related information. Complementary information includes graphics associated with the contextual meaning of the textual information.

These and other aspects, features, and various combinations may be expressed as methods, apparatus, systems, means for performing functions, program products, etc.

Other features and advantages will be apparent from the description and the claims.

### DESCRIPTION OF DRAWINGS

FIG. 1 illustrates a smartphone presenting text messages.

FIG. 2 is a block diagram of components of the smartphone presented in FIG. 1.

FIG. 3 is a block diagram of an Internet-based computer network that distributes information for use with text messaging services.

FIG. 4 is a block diagram of a telecommunication core network in communication with smartphones via base stations.

FIG. 5 illustrates presenting context based upon for a text message.

FIG. 6 illustrates historical data being used to create poll information.

FIG. 7 illustrates using natural language processing for message translation.

FIG. 8 illustrates inserting additional context based information.

FIG. 9 illustrates inserting potentially related content.

FIG. 10 illustrates inserting comparative data.

FIGS. 11 and 12 illustrate inserting complementary information.

FIG. 13 illustrates presenting a message with comparison information.

FIGS. 14 and 15 illustrate publically available and sharable messages.

FIG. 16 is a flowchart of context-based operations of a text messenger.

FIG. 17 is an example of a computing device and a mobile computing device that can be used to implement the techniques described here.

### DETAILED DESCRIPTION

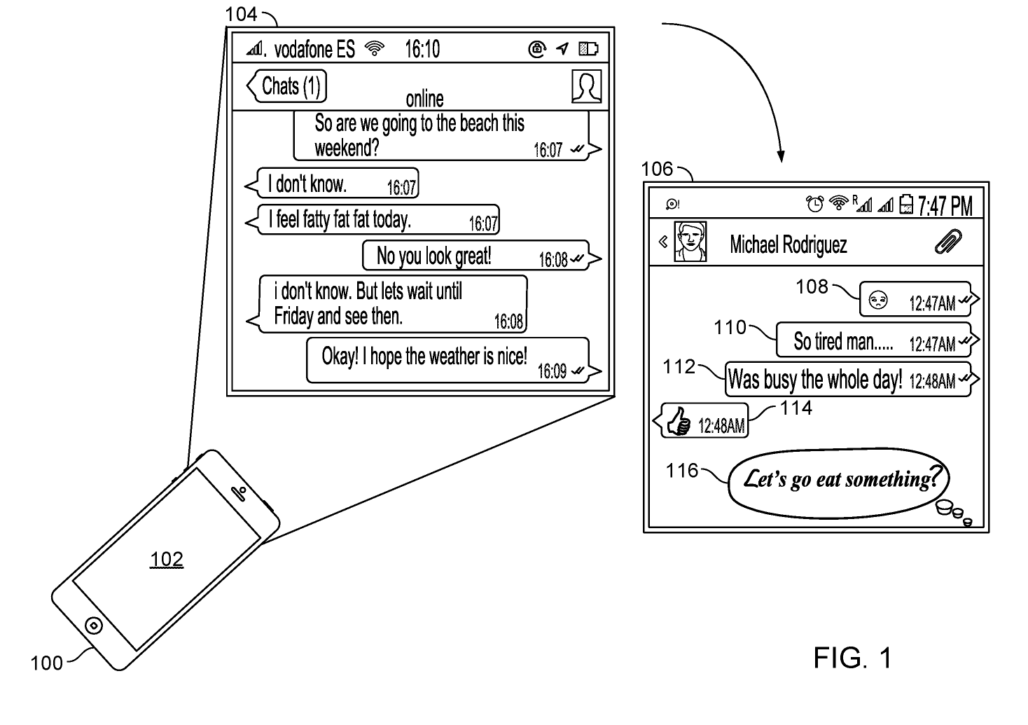

Referring to FIG. 1, a computing device (e.g., a smartphone 100) includes a display 102 that presents an interface 104 for exchanging text messages with the user of another device (e.g., a similar smartphone or other type of computing device). Simply including text, such text messages can appear rather similar and far from eye-catching to a recipient viewer. In some conventional text messaging systems, contrasting colors, different positions on the interface, etc. are typically employed to distinguish messages from the device user and other individuals (e.g., text messages originated by the user device are positioned in one location of the display while messages from another are located at a different position). For both users, the text messages employ the same font and include text content. As such, a considerable number of messages be passed between individuals to exchange needed information.

By incorporating additional content into messages, additional information may be provided to the users as they exchange messages (for example, graphical information can be embedded into a message to convey information related to or unrelated to the message content). Interactive information in the form of pre-defined questions, polls, etc. may be added to efficiently collect information from users. Such graphical, interactive, etc. additional material may originate from a variety of sources, for example, graphical features associated with a brand of an entity (e.g., commercial company) may be incorporated into the messaging. Along with producing more eye-catching messages, such additional material may also assist the owner of the brand. By recognizing the stylistic features, the brand is exposed to the users as they focus upon the messages being exchanged. Interactive information such as polls, surveys, etc. can provide information (e.g., user responses) that may be useful for a number of entities. Along with assisting with the creation of messages (e.g., identifying a meeting location for a group of individuals), brand related information (e.g., product feedback) may be collected and provided to a brand owner. Further, by allowing the use of a brand style to propagate to others (e.g., a recipient of a message infused with the style of a brand can be allowed to send messages that use the brand style), text message users in effect become an advertising source for the brand.

Additional material may also be selected based upon other information sources. For example, information related to individual users such as historical information (e.g., user preferences, character traits, previous choices and selections, etc.), personal information (e.g., calendars entries, current location, etc.), etc. may be used for identify content for presentation. Provided access to an individual's calendar (e.g., electronically stored on the user's smartphone), information can be attained to efficiently assist with event planning or other things without significantly engaging the user (e.g., calendars can be analyzed to determine availability).

In this illustrated example, another interface 106 is presented on the smartphone 100 that allows text messages to include stylistic features of commercial brands and other sources. In this example, a series of text messages 108-112 are received by the smartphone 100. Two of the messages 110, 112 include just text entered by the sender while another message 108 uses an icon to represent an emotion (e.g., that the user is tired) and is absent any text (often referred to as “emoticons”). The user of the device 100 first sends a reply message 114 that similarly uses an icon to convey an emotion. The sender that initiated the exchange of text messages then sends a message 116 that includes textual content that employs the stylistic brand features associated with the Reese's Peanut Butter Cup of the Hershey Company (of Hershey Pa.). Through the use of the brand's style, multiple messages may be conveyed by the single text message 116. For example, along with the message provided by the textual content (e.g., asking if the other user is hungry), the message 116 can also be suggesting a food of interest. By using this brand style, the message 116 can be considered as advertising the brand (e.g., Reese's Peanut Butter Cups) based on instructions from the message creator (e.g., the brand style is user-selected for message creation). Further, embedded within the message, the brand is more likely to be noticed by the users compared to brand information (or advertisement material) being presented outside of the message listing (e.g., banner advertisements located on the periphery of the listing).

These stylistic features can provide various types of information to a viewer; for example pictures, video, etc. types of stylistic features can provide style information associated with the imagery of a brand. One or more particular fonts associated with the brand can include a stylistic feature that provides visual style information of the brand to a viewer. A jingle, audible slogan, etc., or other similar stylistic feature (provided by one or more files, etc.) can provide audible stylistic information to a viewer. In this example, style features are associated with a particular product of a brand owner, however other sources may provide such stylistic features. For example, various types of entities associated with products, services, etc. may provide a brand style. Stylistic features may also be developed by individuals not associated with a product or service and may simply develop as stylistic effects on their own. By allowing text messaging users to somewhat control the distribution of brand information, brand knowledge may be distributed among large numbers of text message users (e.g., by being circulated rapidly over the Internet) and potentially advertise the brand in a viral manner compared to conventional advertisement campaigns.

Along with the brand style, other information may be conveyed through the use of such styles. For example, locations associated with brands may be subliminally suggested by the appearance of the brand style. With reference to the illustrated example, the sender and/or recipient of the text message 116 may associate a particular location (e.g., candy store, ice cream shop, etc.) with the presented brand. Along with reducing the effects of banner-blindness, smaller displays (e.g., of mobile devices) may be better suited for presenting the brand styles within messages compared to other locations of the display (which may not be easily readable by the user of a mobile device). With user interaction needed (e.g., to select a brand style for embedding), users are given an option whether to “opt in” or “opt out” of allowing such style information to take part in text messaging conversations. Various types of functionality may also be provided to complement the text messaging capability. For example, information sources may be exploited to supplement the content of a text message. Such sources may be associated with individuals involved the text message exchange (e.g., information related to the text message sender, one or more message recipients, etc.), sources independent of the message exchange (e.g., e-commerce websites, weather data sources, etc.), etc. Additional functionality may include processing user-supplied information such as the text messages; for example, information may be extracted from an entered text message and processed to identify the context of the message (e.g., the topic of the message). By providing context, the extracted information can provide the meaning of a portion of the message, the entire message, etc. Once identified, additional processing may be executed to assist the individuals involved in the message exchange. For example, further information related to the context may be collected and presented to one or more of the individuals. Such information can be collected from sources completely separate from the individuals (e.g., the current weather at a location identified in a text message), sources associated with the individuals (e.g., calendar entries of each individual to identify potential conflicts with a meeting be scheduled through the text message exchange, etc.), etc. By using the content of the messages, additional information can be attained and presented to text message users without substantial input from them, thereby allowing the users to focus on exchanging text message and not pausing to collect related information (e.g., weather conditions, potential calendar conflicts, etc.). Along with improving efficiency of exchanging messages between two or more individuals, the automated technique of providing related information frees users from having to identify and execute the appropriate applications (e.g., a weather information application), access appropriate websites (e.g., an e-commerce company's webpage), etc.

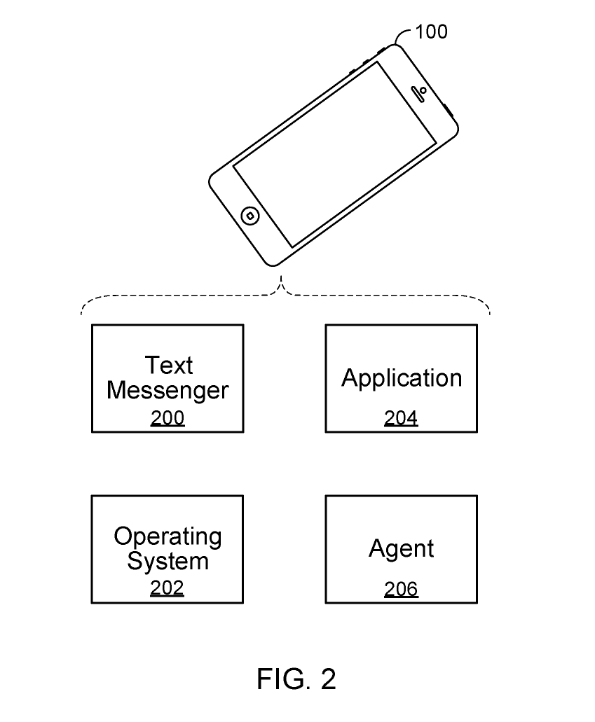

Referring to FIG. 2, various architectures, processes, etc. may be employed to use style information (e.g., brand styles), interactive information, contextual information, etc. in text messages. In this particular example, a text messenger 200 is executed by the smartphone 100 and can provide various types of functionality, such as creating, editing, etc. text messages, along with style-based operations to embed style information, related data (e.g., weather conditions), interactive information (e.g., queries, polls, surveys), etc. into text messages. Information may also be exchanged with other portions of the smartphone 100 (e.g., an operating system 202, one or more applications being executed by the device (e.g., an application 204), one or more applications awaiting execution (e.g., stored on the device), etc.). In some arrangements, the text messenger 200 may execute in concert with a web browser or other applications for sending and receiving style information, interactive information, other types of information and data, etc. with other computing devices (e.g., other smartphones). For example, information associated with brand styles may be downloaded from remotely located computing devices just as messages that contain style information may be sent to other devices. Still further, recently developed styles (e.g., a style produced by an individual) may be uploaded to a remotely located server to allow access to the style by others. Other types of user-generated content may also be used by the system; for example, imagery created by a user (e.g., photographs taken be a user) that includes branded products, band logos, particular locations, and other types of subject matter. In some arrangements, other functionality may be provided to assist operations of the text messenger 200. For example, information representing different fonts may be monitored to determine if the appropriate fonts are present at the smartphone. Applications, websites, etc. may also be checked such that appropriate applications, versions, etc. are used. For example, updating of a weather data collecting application may be detected and appropriate action taken (e.g., alerting the text messenger 200, application 204, etc.) so the updated version of this application is used for data collection. In a similar manner styles, fonts, etc. may be monitored. If a particular style is selected for creating messages and a needed font is not present at the smartphone, the lacking font can be detected and corrective actions taken to attain the missing font. One or more techniques can be used to monitor the style features, applications, etc. present at the smartphone to take steps to collect needed information. For example, a software agent 206 may be executed by the smartphone 100 to monitor resident fonts, applications, websites, other features (e.g., graphics, etc.) associated with embedding style information, interactive information, etc. into text messages, etc. If font information (other types of style information, an application update, etc.) is detected as missing, one or more operations may be executed by the agent 206 either alone or in concert with the smartphone 100 in order to take corrective action. For example, the agent 206 may initiate the sending of a request for attaining the appropriate font information to support the embedding of the selected style into one or more text messages. Such software agents can be considered as software modules that execute in a substantially autonomous manner. For example, upon being delivered to the smartphone 100, a software agent may operate without considerable user interaction. By operating in a somewhat flexible manner, the software agent can adaptively identify needed fonts, graphics, application updates, etc. for creating and presenting text messages. Operations of the agent may also include monitoring user interactions, for example, with the text messenger 200. For example, the number of instances that particular style is selected, when related information (e.g., weather information) is viewed, etc. can be determined from commands (e.g., retrieve style) initiated by the user. In some arrangements, the software agent 206 may execute in a substantially continuous manner. The software agent 206 may monitor various types of user interactions, for example, with the text messenger 200, the application 204, etc. to develop various types of information (e.g., user preferences, etc.).

Along with creating text messages for delivery and presenting received text messages, the text messenger 200 may provide other functionality for using styles, such as brand styles, with text messaging. For example, multiple styles may be stored (in memory) and managed by the text messenger 200. The use of interactive information (e.g., queries, polls, etc.) in messages may also be managed by the text messenger 200. From a received message (that includes style information), other messages may be created that use the style information (e.g., style features may be stored and later retrieved to create a new message that employs some or all of the features). Similarly, information received (e.g., query or poll responses, feedback etc.) may also be used creating new messages (e.g., a lunch meeting time may be finalized). Along with allowing styles to be created, edited, deleted, stored, etc., the text messenger 200 may request style information, style features (e.g., fonts, graphics) etc., as needed. For example, style information, style features, interactive information (e.g., queries, polls), etc. may be requested from external sources and stored on the user device (and retrieved as needed to prepare a message). One or more techniques and methodologies may be implemented for attaining such information. For example, font information may be provided in an incremental manner (e.g., as font characters are needed) from one or more locations (e.g., remotely located servers) using transfer techniques as described in “Font Data Streaming”, U.S. Pat. No. 9,319,444 issued Apr. 29, 2016, the entire contents of which are hereby incorporated by reference.

Along with the ability to download font information along with other types of information (e.g., style information, interactive information), the smartphone 100 may also execute operations to provide style information to other devices, locations, etc. For example, upon creating style information that may be embedded into a text message, data may be uploaded to other locations for various activities such as storing the style information, allowing it to be used by other devices for presenting stylized messages, etc. The text messenger 200 may also interact with one or more applications being executed by the smartphone. Through such interactions, the text messenger can exchange data with the application (e.g., for using the data with a stylized text message). The execution of an application (e.g., application 204) can also be initiated through operations of the text messenger 200. In some arrangements, the text messenger 200 may produce a stylized message that includes objects (e.g., radio buttons, links, etc.) that allow viewers of the message to initiate the execution of an application located on the viewing device (e.g., a smartphone) or other device (e.g., a remotely located server in communication with a viewing device).

In some arrangements the application 204 may operate to integrate the operations of the text messenger 200 with other functionality. For example, assisting user decision-making along with providing text messaging capabilities. Polling, surveying, and other types of techniques for collecting user decisions may be employed by the application 204. In one example, functionality of the application 204 can assist with event planning (e.g., selecting attendees, identifying event location, time, event length, etc.). Polling may also be executed by the application 204 to assist with event planning; for example, information may be solicited from a group of individuals for event planning (e.g., select event type, location, availability, etc.) or another type of situation in which polling a group would be helpful. To provide such capability, application 204 may take one or more forms on the smartphone 100 or other type of computing device. The application 204 may be an “app”—that can be considered a self-contained program, piece of software, etc. designed to provide a particular purpose (e.g., for a mobile device). The application 204 may also be provided in a form conducive for network environments such as a program that executes over a network (e.g., the Internet), e.g., in a repetitive and automatic manner, triggered for execution, etc. and which can be considered a “bot” program. In some arrangements, the application 204 operates in concert with one or more other applications (e.g., Internet-based applications) such as text messaging environments like Facebook Messenger, Kik Messenger, etc.

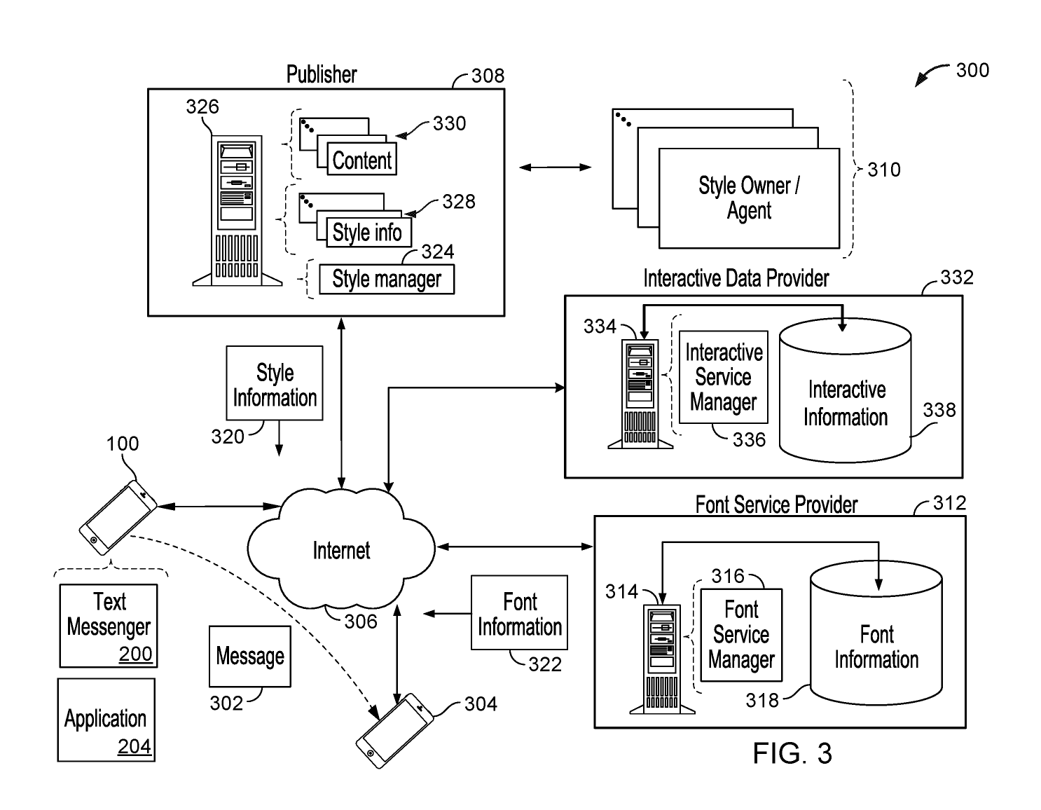

Referring to FIG. 3, a computing environment 300 is presented that is capable of providing and managing the use of information such as style information (e.g. brand styles), interactive information (e.g., user-selected information, polling information), etc. in text messaging applications and systems. For example, information (e.g., text, related information, style information, etc.) can be embedded into messages exchanged between user devices. While text messages are referred to throughout this disclosure, various types of messaging techniques may be employed; for example, short message service (SMS) messaging, instant messaging services (e.g., over-the-top (OTT) messaging), etc. and other types of text based communications may be utilized. As illustrated, a stylized text message 302 can be created by the text messenger 200 of the smartphone 100, using locally stored style information (along with other information), and sent to another smartphone 304 (via the Internet 306). To manage the use of the style information (e.g., by the smartphones 100 and 304), a publisher 308 is included in the environment 300 that interfaces with style owners 310, such as entities that own a particular brand whose style information, features, etc. can be embedded into text messages. For example, particular fonts, graphics, colors, etc. may be used to develop a brand for a well-known product or service. This stylistic brand information can be provided by an owner of the brand in order to allow the publisher 308 to propagate the brand among many users (e.g., to increase the visibility of the brand for potential customers, geographical regions, etc.). In some instances, the style owners may use a third party (e.g., an agent) to assist with developing campaigns, policing brands, etc. and may authorize this party to interact with the publisher 308 on the style owner's behalf (e.g., authorize an agent to send style information, style features, etc. to a publisher). In some instances, the style owners may have created some or all of the features of the style. As such, along with using styles of products present in the marketplace for considerable time periods, some relatively recently developed styles may be received by the publisher 308 directly from the creator, developer, etc. In some instances, a publisher may develop and distribute message styles for gain (e.g., profit). For example, message styles may depict particular hobbies, activities (e.g., sports, games, etc.), familiar and recognizable nature sites for hiking, woodworking, photography, motorsports, fishing, sailing, music, and various other topics and areas of interest.

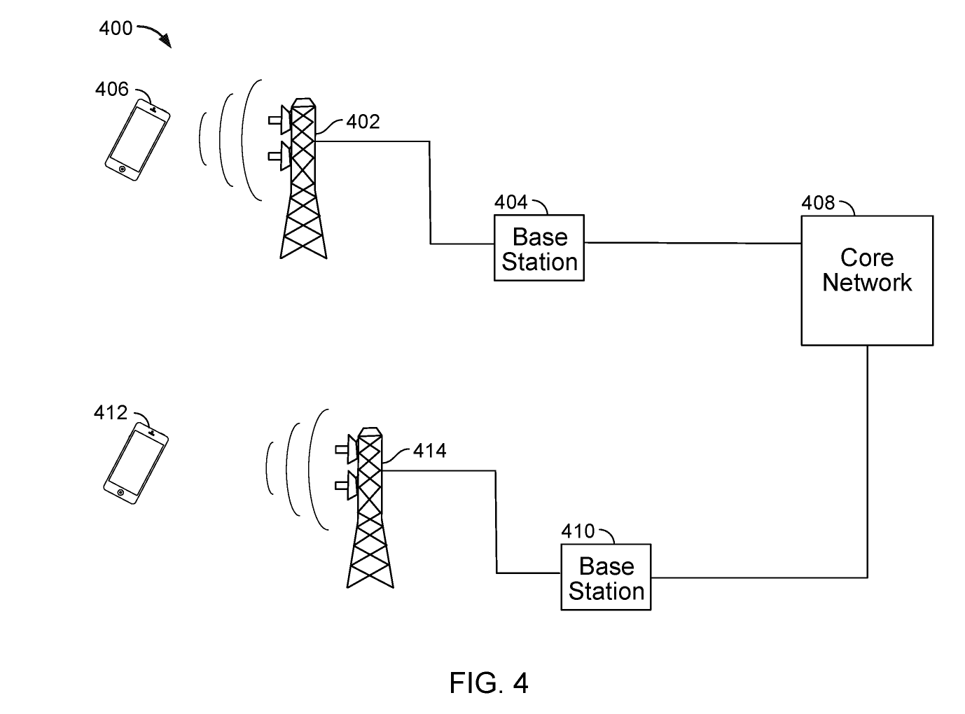

Referring briefly to FIG. 4, other types of telecommunication networks may be utilized for exchanging messages. As illustrated in the figure, text messaging services such as short message services (SMS) may be provided by a radio access network (RAN) 400 that includes a conventional antenna tower 402 capable of transmitting and receiving electromagnetic signals that are provided from or to a base station 404. One or more signaling techniques and standards may be implemented by the base station 404 to establish communication links (via the antenna tower 402) with user devices such as a smartphone 406. For example, techniques and standards associated with the Universal Mobile Telecommunications System (UMTS), code division multiple access (CDMA), wideband (W-CDMA), etc. may be implemented such that multiple user devices may establish communication links and access the base station 404. A core network 408 (e.g., a mobile switching center) is connected to the base station 404 for exchanging messages with other user devices. For example, another base station 410 is connected to the core network 408 for allowing message exchanging with another smartphone 412 (via another antenna tower 414).

Returning to FIG. 3, along with interacting with style owners (or their agents), the publisher 308 may interact with other entities regarding style information. For example, a font service provider 312 can provide font information for presenting stylized messages. In some instances, the font information may be provided to the publisher 308, while in other instances the font service provider 312 may provide font information as needed to user devices (e.g., a recipient smartphone via the Internet 306). In the illustrated architecture, the font service provider 312 includes a server 314 that can execute a font service manager 316 (e.g., implemented in software, hardware, or a combination) that manages the various fonts and related information that can be provided to other devices and components of the environment 300 (or external to the environment). Font libraries and libraries of font information may be stored in a storage device 318 (e.g., one or more hard drives, CD-ROMs, disk arrays, etc.) on site (at the font service provider 312) or offsite (e.g., implementing cloud-based storage architectures). Being accessible by a server 314, the libraries may be used, along with information provided (e.g., included in a request message from the smartphone 100), to attain the appropriate font information. Illustrated as being stored in a single storage device 318, the font service provider 312 may also use numerous storage techniques and devices to retain collections of fonts and related font information (e.g., fonts for multiple languages, styles, etc.). The font service provider 312 may also access font information at separate locations as needed. For example, along with identifying language fonts potentially needed for the smartphone 100 and other user devices, the server 314 may also be capable of collecting fonts associated with other languages, etc. from one or more sources external to the font service provider 312 (e.g., via the Internet 306). To manage the fonts, a database (or other technique for structuring and storing data) can be stored at the font service provider 312 (e.g., on the storage device 318) and include records that represent fonts and related information. Other functionality may also be provided; for example, the font service provider 312 may perform operations (e.g., tracking, monitoring, etc.) regarding the font information to be sent, preserved, used, etc. For example, records may be stored (for future use) that reflect particular fonts that have been requested from, provided to a computing device, etc. The font service provider 312 may also perform operations associated with such text messages. For example, operations may be executed for aggregating data (e.g., text and survey data) into a message. In some instances, aggregation related operations may be distributed between the font service manager 316 and the application 204 (being executed at the smartphone 100). Polling operations may also be executed by the font service manager 316, the application 204 individually or in concert. For example, upon collecting polling information from a user of the smartphone 100 (and/or other devices), the application 204 may provide the information to the font service manager 316 for processing (e.g., comparing with other poll results), storage (in the storage device 318), etc.

To convey a text message that includes information (e.g., style information, polling information, etc.) to a recipient device (or multiple devices), one or more techniques may be employed. For example, the text message 302 may include data (e.g., links) for accessing appropriate style information being stored at the publisher 308 and potentially at other locations (e.g., links included in the message provide access to fonts stored at the font service provider 312). Upon receiving the text message 302, operations can be executed by the recipient device to request needed style information (e.g., immutable style information, style features, etc. associated with a brand). For example, by using a link included in the received message, one or more files containing style information 320 can be sent to the recipient device (e.g., the smartphone 304) for presenting the contents of the text message 302. Other information such as polling information may be provided with a link included in a message. Similarly, font information may be provided in one or more files 322 to the recipient device (e.g., as initiated by links included in the text message). Correspondingly, polling data and other types of information may be exchanged among the device, entities, etc. using one or more files.

To appropriately control the distribution of style information, a style manager 324 is executed by a server 326 that is located at the publisher 308 (although the functionality of the style manager may be distributed across multiple locations in some arrangements). The style manager 324 may manage the style information (e.g., immutable style information, style features, etc.) for multiple brands. In managing the information, the style manager 324 may also apply conditions for allowing the information to be accessed. For example, conditions may include rules that grant access for a period of time, based on a subscription being valid, based upon one or more particular products or services being purchased, etc. As illustrated in the figure, style information 328 (which can be included in the file 320) is stored at the publisher 308 and is accessible by the server 326. Other architectures may be implemented for storing style information; for example, all of the information, portions of it, etc. can be stored at locations external to the publisher 308 (e.g., in a cloud-based architecture accessible by the publisher 308). In some instances, additional content may be provided with the style information (e.g., based upon the text message received at the recipient device) such as imagery, video, audio, etc. As illustrated in the figure, such content 330 may be stored at the publisher 308, however, the content may be stored at one or more other locations (e.g., in a distributed manner), such as multiple locations that include the publisher 308. In some arrangements, content delivery to a user device (or other type of recipient) may initiate the sending of style information (e.g., immutable style information, style features, etc.).

As illustrated in FIG. 2, software agents may be employed to provide or assist with some of the functionality provided by the environment 300. For example, a software agent (e.g., provided by the font service provider 312) may be executed by each user device (e.g., smartphones 100 and 304) to identify needed information and correspondingly initiate sending a request (e.g., for style information, style features, etc. from the publisher 308, font information, interactive information such as polling information for aggregating, etc.). Operating in an autonomous manner (and in some instances also continuously), an agent is generally not inhibited by other processes (e.g., other agents) and may have the capability of learning through its functioning over a period of time. For example, the agent may repetitively monitor the text to be rendered on the user device and correspondingly request style information, font information, etc. as needed. Such functionality may also be provided, or partially provided, by the publisher 308, the font service provider 312, etc. For example, as style or font information is requested by the user device (e.g., by the text messenger 200 executed by smartphone 100), the publisher 308 or the font service provider 302 may determine which style and/or font information is needed by the device (e.g., by tracking the styles, fonts, etc. present at the smartphone, the capabilities of the device, etc.) and provide the information. In another arrangement, the font service provider 312 and the publisher 308 may work in concert (e.g., with other information sources) such that appropriate style and/or font information is provided to user devices.

In a typical text messaging interaction, a text message is created by one device (e.g., the smartphone 100) and is sent via a file (e.g., text message 302) to a recipient device (e.g., the smartphone 304) over one or more networks (e.g., the Internet 306, a wireless network, SMS systems, etc.). To create a message, style information which has been previously requested from and provided by the publisher 308 is selected for use by the operator of the device. In a similar manner, information (e.g., interactive information) provided by the application 204 (e.g., weather information, polling information, etc.) can be aggregated into the message. One or more other sources may provide interactive information (e.g., queries, polls, etc.) for inclusion in messages. Upon receipt of the message, operations are executed by the recipient device to prepare and present the stylized message; for example, style information is requested and received from the publisher 308 and corresponding font information included in the style information is requested and received from the font service provider 312. Additional information to be aggregated into the message may be provided by the font service provider 312, one or more other sources, etc. For example, information associated with users (e.g., user preference data) may be attain from the storage device 318 (of the font service provider 312) and/or other sources and used to identify polling options based on the preferences (e.g., a user's top four favorite lunch locations). In some instances the style information (or other type of information) may already be present at the recipient device, thereby removing the need to request the information from the publisher 308, the font service provider, or other entity. In some arrangements, based upon received information (e.g., style information etc.), operations may be executed at the device to determine (e.g., estimate, speculate, etc.) other font information that may be needed in the near future. For example, an agent executed at the recipient device may monitor the data present at the device for presenting particular characters of a font. Based upon the characters present, the agent may determine which characters would soon likely be needed. For example, rules may be checked (e.g., is the most used character, “e”, present for this font?) to identify one or more characters to request from the font service provider 312. Such subsetting techniques, incremental subsetting techniques, etc. are described in “Network Based Font Management for Imaging Devices”, U.S. patent application Ser. No. 13/692,593 filed on Dec. 3, 2012, the entire contents of which are hereby incorporated by reference. Similarly, agent actions may be used for requesting other types of style information, for example, based upon the types of styles previously selected by a user (e.g., a style associated with particular brands) the agent may identify similar styles and accordingly send a request (or requests) to the publisher 308. Upon receiving the text message file 302, the recipient device can interrogate the file and appropriately request style information as needed (e.g., one or more font characters from the font service provider 312, style information from the publisher 308, etc.). In some instances subsets of information (e.g., font characters) are requested in an incremental manner to complement previously received data (and reduce redundant transmissions).

Software agents (e.g., as illustrated in FIG. 2) can perform operations for user devices that transmit messages, recipient user devices, etc. In some instances, prior to (or during) message creation, the message-initiating user device may attain (e.g., download) needed style information (e.g., from a service) and may store the style information for reuse. For example, the style information may be retrieved in response to a message is received by the device and being analyzed (to identify needed style information). In some instances, a message-initiating user device may have style information residing on the device (e.g., a complete graphics, font set, etc. previously requested, attained through use of a QR code, etc.). Upon initiating transmission of a created message (e.g., a user presses a displayed “send” radio button), an agent executed on the user device may scan the message and collect various information for assisting with efficient rendering of the message on a recipient device (or multiple recipient devices). The agent can determine what particular style information will be needed by the recipient device(s) (e.g., graphics, fonts, font character subsets, etc.) and send a message to one or more style information sources (e.g., the publisher 308, the font service provider 312) as an alert to prepare the information since a request for the information may soon be received (at the style information source(s)). By sending such an alert, style information can be appropriately prepared before being requested from the recipient user device, thereby improving message transmission efficiency. In some arrangements, the alerting agent may also instruct the style source (e.g., the publisher 308, the font service provider 312) to send the needed style information to the recipient user device. Similarly, other types of information may be identified by the agent needed for message presentation; for example, particular content (e.g., weather data, queries, polls) to be included in a message may be identified and an alert may be sent to the source of this content. By removing the need for a request from the recipient device, efficiency is further improved as less information would be requested from recipient user devices and request traffic would reduce. However in some instances, a request being sent from the user device may be more efficient. Agent operations may also be executed at one or more recipient devices to attain needed information such as style information. For example, upon receiving a message transmitted from a user device (e.g., the device that created the message), an agent executed at the recipient device may scan the message and identify needed information (e.g., style information, interactive information, particular content, etc.). One or more requests may be sent to information sources (e.g., the publisher 308, the font service provider 312, other sources) to initiate the transmissions of the needed data. In another arrangement, content (e.g., audio, video, multi-media content, etc.) may be sent to a recipient device (or multiple devices) and the transmission source of the content may identify needed style information and initiate the transmission of the style information to the recipient device(s). For example, content (e.g., a sequence of content packets, a data stream such as a stream of video content, etc.) may be sent from a content source (e.g., the publisher 308, the font service provider 312, etc.) and style information (e.g., graphics, fonts, font subsets, etc.) may be identified and sent with the content or through a separate communication channel. In some arrangements, multiple sources may operate in concert to provide such a data stream to one or more recipient devices. For example, a publisher may provide a stream of content (e.g., audio, video, multi-media content, etc.) to the recipient device(s) while a font service provider provides needed font information (e.g., fonts, characters, font subsets provided in an incremental manner, etc.).

In some arrangements, predictive operations may be executed at one or more locations to identify information (e.g., style information, user preference data, etc.) in advance of need. For example, upon a series of messages being exchanged between two or more user devices, predictive operations (e.g., executed by the publisher 308, the font service provider 312, etc.) can identify future needs such as graphics, fonts, font characters, font subsets, etc. Such predictive operations may utilize information (e.g., style information, fonts, etc.) present at one or more of the devices. For example the presence of fonts, font characters, etc. may be monitored at each user device to predict style information that may be soon needed (e.g., font characters to complete a font set). In some instances, predictive operations may be executed using the message content exchanged (e.g., identify font characters already present at a user device from messages and provide characters not yet used in a message, incrementally send font characters based on previously used characters, etc.), or predictions may be made independent of message content (e.g., send font characters that have a historically high frequency of use, etc.). Similar methodologies may also be utilized.

In some arrangements, the information sources (e.g., style information sources) may also execute operations to determine the data that should be provided to a user device (e.g., smartphone 100). For example, the style manager 324 executed at the publisher 308 may monitor brand styles present and accordingly send style information. The font service provider 312 may perform similar operations by monitoring the fonts, font characters, etc., present at a user device (e.g., the smartphone 100). For example, the font service manager 316 may determine that a certain percentage of font characters (e.g., 90%) are present at a user device and initiate the transmission of the remaining 10% to complete the font set (without any request being sent from the device). The font service provider 312, a software agent (being executed at a user device), one or more application (also executed at the user device), etc. operating alone or in concert may determine the fonts, font characters, etc. being supported by the user device and appropriately initiate transmission of lacking fonts, font characters, etc. if one or more thresholds are broached.

While information (e.g., style information, user preferences, etc.) may be provided to user devices in order to properly present text messages, such information may also be provided for other types of content presenting applications. For example, content 330 stored at the publisher 308 may be sent (e.g., broadcast) to one or more devices and include style information as needed for presenting the content. For instance, content may be sent in a sequence of data packets (e.g., a data stream) to present content, such as video, audio, graphics, etc., to an viewer (of a user device). Information (e.g., style information) may be incorporated into the sequence of content packets to enhance the content presentation. Such information, style information, may also be selected for downloading from the publisher 308, the font service provider 312, etc. For example, prior to preparing a text message, a user may interact with an interface of the text messenger 200 (or another application) in order to select one or more styles (associated with one or multiple brands) and initiate the downloading of the corresponding style information to the user device (e.g., smartphone 100). Such interactions may initiate a request being sent to the font service provider 312 for appropriately downloading one or more fonts as determined from the user selections. Similar to using an interface provided by the text messenger 200 to select a style for downloading, other vehicles may be utilized for style selection. For example, upon receiving and presenting a stylized message on a recipient device (e.g., smartphone 304), a user can interact with the message to initiate the downloading of the style information. For the situation in which the style information is downloaded for presenting the message (as initiated by a link included in the stylized text message), user interaction with the message may result in the style information being installed (e.g., stored) on the device for local operations (e.g., creating a message that is infused in this style).

By downloading different styles and related information, a style library may be initiated, grown and shared with others. For example, by sending a text message that employs a particular style (e.g., associated with product or service brand), the recipient may be encouraged to request the style for themselves and propagate the style to still more users (e.g., by sending individual messages, broadcasting messages to many users, etc.). Along with collecting different style types through use, operations of the text messenger 200, the publisher 308, etc. may assist with developing such style libraries. For example, the text messenger 200, an agent, etc. executed by the smartphone may monitor the locally residing styles and may recommend additional styles that may be downloaded from the publisher 308 or from other sources. Recommendations may also be based upon other information such as characteristics, demographics, geographic location, etc. of the user (e.g., based upon one or more user profiles stored at the device, publisher 308, etc.). Along with assisting the requesting of styles, the text messenger 200 may also perform library functions such as deleting, moving, manipulating style information, stylistic features, etc. locally stored at the device. As such, libraries of immutable style information, style features, etc. may be developed and used to access such brand-related information for use in text messages. Such functionality may also be utilized for architectures in which the style information is stored by using one or more remotely located computing devices (e.g., servers) such as in a cloud computing system.

Along with providing style information to user devices and other types of computing devices, the publisher 308 interacts with style owners (and/or their agents) to collect information representative of the style (e.g., graphics, video, audio, color templates, etc.). Additionally, the brand owner 310 may provide other information to the publisher 308 that is associated with the use of this style information. For example, conditions can be provided to control user access to style information (e.g., immutable style information, style features, etc.). For example, one or more restrictions may control access based upon factors such as user characteristics (e.g., age, user profile information, etc.), periods of time (e.g., an access period), geography (e.g., restrict use to particular regions), one or more business rules (e.g., check for a valid and active subscription, etc.), device capabilities (e.g., user device model, display size and resolution, etc.). Conditions may also include temporal aspects; for example, users may be granted access to style information associated with a product that is marketed over a particular time period (e.g., the run up period until a motion picture is released, the period the motion picture is in theaters, the season of a television series, etc.). Similar to restrictions, incentives may be used.

One or more techniques may be utilized for interacting with style owners (and/or their agents) for exchanging such information with publishers. For example, various types of editors, interfaces, wizards, software suites etc. may be utilized to assist with providing, selecting, etc. graphics, such as colors, imagery, video, audio, fonts and other types of stylistic features. Typically the style owners interact primarily with the publishers, however, in some arrangements the information may be exchanged with other entities (e.g., the font service provider 312) for preparing style information that may be accessible by end users. Along with providing information (e.g., selecting graphics and fonts), the style owners may also receive information from the environment 300. For example, as style information is employed in text messages, feedback data may be provided to the style owners for monitoring use and further analysis (e.g., determine if the brand is gaining traction in a marketplace, with a particular type of user, etc.). Such feedback (e.g., text message sender identification, recipient identification, etc.) may first be received by the publisher 308, font service provider 312, etc. and then forwarded to the style owner for potentially processing prior to delivery. In other arrangements, feedback data may be directly received by the style owners from end users (e.g., provided from smartphone 100 and 304). For example, agents being executed by user devices may collect and provide use data to the style owners. Operations associated with delivering and presenting text messages may initiate the sending of feedback information to the style owner. For example, when a recipient user device (e.g., smartphone 304) requests information from the publisher 308 and/or the font service provider 312, feedback information (e.g., an indication that the style is being used) may be provided to the style owner (or an agent of the style owner). Upon receiving this information, further analysis may be executed, for example; adjustments to style information may be initiated based upon user feedback. In some instances such feedback may assist with finalizing selections of style features. For example, different types of styles may be provided to a variety of users and based upon their feedback, particular feature variants may be selected for branding use by the style owner. Feedback may also assist with distributing style information; for example, based upon the feedback provided to the publisher 308 and/or the style owner 310, adjustments (e.g., restrictions) may be applied to the distribution of the style information (e.g., targeting particular user types for allowing access to the style information, identifying particular geographical regions, etc.).

Along with interacting with style owners (and potentially their agents), publishers, such as publisher 308, may use one or more techniques for providing style information to the user devices in need, that have requested the information, etc. For example, upon receiving a text message, the recipient user device (smartphone 304) may interact with the publisher (e.g., via a link in the text message) to request and retrieve needed information. Similarly, the text message may include information for the recipient user device to interact with the font service provider 312 (e.g., for retrieving one or more needed fonts, font characters, character subsets, etc., for presenting the content of the text message). The publisher 308 can also manage the resident style information 328 (e.g., that is locally stored). For example, as the style owner provides updated data (e.g., different graphics, use time periods, restrictive conditions, etc.), the style information 328 stored at the publisher 308 can be correspondingly updated (e.g., appended, added to, deleted, etc.) by the style manager 324. Various events may trigger updating; for example, feedback information regarding a brand, style information, style features, etc. may be received (e.g., by a brand/style owner) that contributes to having a brand updated (e.g., update/create new style information, style features, etc. associated with the brand). The feedback may be provided by one or more entities, for example, end users (via their devices), publishers, and other potential information sources. Such information may also be provided to other entities internal to the environment (e.g., the font service provider 312) or external to the environment. The publisher 308 may also manage data associated with users; for example, subscriptions for being allowed access to the stored style information may be managed (e.g., checked for valid subscriptions, request subscriptions renewals, etc.).

Interactions with the publisher 308 may also include exchanging data with the font service provider 312. For example, font information stored at the font service provider 312 may be updated as new materials (e.g., adjustments to font characters) become available (e.g., from font developers, etc.). However, information may also be sent to the font service provider (e.g., at a style owner's request) to adjust a font. In some instances, the update request may be sent from the publisher to the font service provider upon indication that style information is being used (e.g., a request from a user device is received at the publisher for the corresponding style information). Such update requests to the font service provider 312 can be initiated by the style manager 324, for communicating with the font service manager 316, both of which can be implemented in software, hardware, or a combination of software and hardware. Similar to the publisher and/or style owner, the font service provider may also receive feedback information based upon the exchanging of stylized text messages. For example, font characters and font character subsetting needs may be determined from information provided to the font service provider 312. Based upon the received information, the font service provider 312 can determine and provide the needed font characters, character subsets, etc. to a user device. Feedback information may be provided to the font service provider 312 from one or more entities; for example, the publisher 308, the style owner (or agent of a style owner) 310, individual user devices, etc. may provide feedback individually or in one or more combinations. Font usage information can be of particular interest to the font service provider 312. Along with determining which fonts are used frequently, less frequently used fonts can be identified; usage trends and estimates can be calculated, etc. Such information can be useful in decisions about allowing access to fonts (e.g., setting subscription rates, etc.). In some arrangements, fonts can reside at the publisher 308 (rather than at the font service provider 312) and correspondingly font requests from user devices can be directed to the publisher. To attain usage information, feedback from the publisher 308 to the font service provider 312 would be needed. Such feedback regarding font usage (e.g., request for individual fonts, etc.) can assist the font service provider 312 in making determinations (e.g., providing similar fonts for availability, removing fonts from availability, adjusting subscription rates, etc.). The font service provider 312 may perform additional operations such as speculating which font sets, font characters, character subsets, etc. may be needed in the future based upon previously provided data and correspondingly send relevant data based upon these speculations. For example, if a relatively small portion of characters (e.g., less than 10%) are needed to complete a font set, the font service manager 316 may initiate the transmission of these remaining characters. In some arrangements, such proactive (or eager) loading techniques may be implemented, or alternatively techniques may be implemented that defer taking action until data is needed (e.g., lazy loading techniques).

One or more information sources may be utilized to provide information such as interactive information (e.g., queries, polls, etc.) to device such as the smartphone 100 for creating interactive messages. For example, an interactive data provide 332 may be accessed via the internet 306 by user devices to attain such information. In some arrangements, such interactions may be initiated during message creation (e.g., by the text messenger 200) to request/collect interactive information (e.g., queries, polls, etc.) needed for preparing a message. Other user device applications such as the application 204 may also be employed to access such information at the interactive data provider 332. In some instances, a message recipient device (e.g., smartphone 304) may access the provider 332; for example, to present a set of selectable options data may be retrieved from the interactive data provider 332 by the user device (e.g., the smartphone 304 retrieves data from the provider 332 as directed by the received message 302). To provide this functionality, a server 334 executes an interactive service manager 336 that is capable of accessing a storage device 338 that contains various types of interactive information (e.g., queries, polls, polling templates, etc.). Sources external to the interactive data provider 332 may also be accessed, via the interactive service manager 336, to collect interactive information. For example, publishers (e.g. the publisher 308), style owners and their agent 310, etc. may be contacted to provide information needed to prepare interactive information (e.g., queries, polls, etc. associated with a particular brand. Data may also be collected from individual users, user devices, etc. For example, responses to queries, polls, etc. may be provided to the interactive data provider 334 for further processing of the results. Data may be appended, edited, etc. and stored in the storage device 338 that reflects the feedback from poll-takers. In some arrangements, a portion (including all) of the functionality of the interactive data provider 332 may be provided by the font service provider 312, another entity, etc. In one example, the interactive data provider functionality may be provided by a messaging service (e.g., an internet-based service for managing the creation, delivery, etc. of text messages). In another instance, the functionality of the interactive data provider 332 may be distributed among multiple entities; for example, such a service may be provided by operations being executed by the font service provider and individual user devices.

Along with being capable of using different types of files and employing different types of data transmission techniques for exchanging text messages among the devices within the environment 300, various transmission techniques may be used for exchanging style information, font information, interactive information, etc. For example, cloud architectures, distributed processing techniques, etc. can be implemented within the environment. Other functionality, executable operations, etc. may be employed by the environment 300, such as techniques described in “Selectable Styles for Text Messaging System User Devices”, U.S. patent application Ser. No. 09/862,356 filed Sep. 23, 2015, “Selectable Styles for Text Messaging System Publishers”, U.S. patent application Ser. No. 14/862,404 filed Sep. 23, 2015, “Selectable Text Messaging Styles for Brand Owners”, U.S. patent application Ser. No. 14/862,499 filed Sep. 23, 2015, and “Selectable Styles for Text Messaging System Font Service Providers”, U.S. patent application Ser. No. 14/862,626 filed Sep. 23, 2015, the entire contents of each are hereby incorporated by reference.

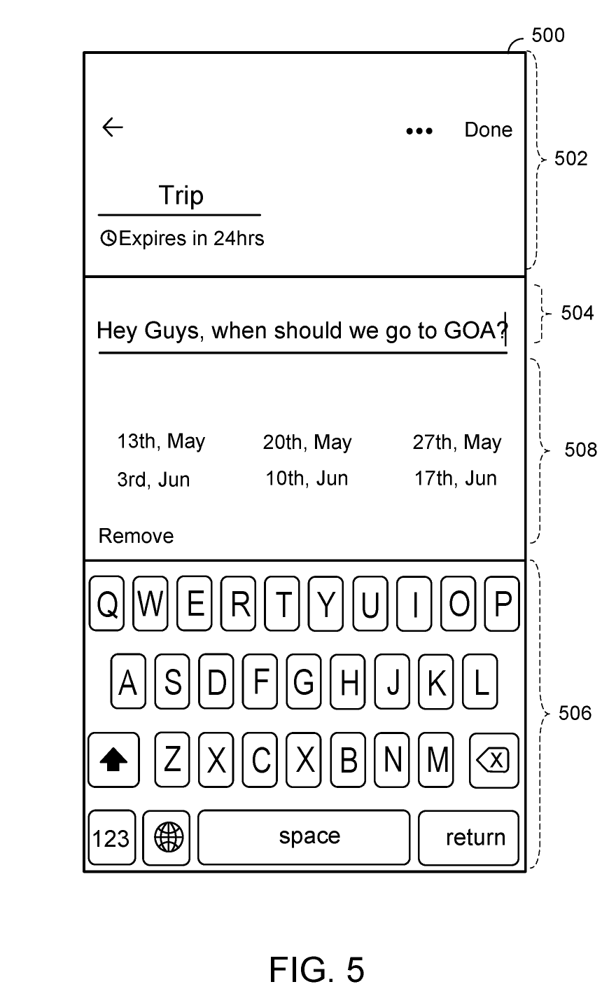

Referring to FIG. 5, an example interface 500 of a text messenger (e.g., the text messenger 200) includes portions associated with different aspects of a message asset being created that includes both textual information and interactive information. In this example, an upper portion 502 of the interface presents an assigned title 504 to the asset (e.g., “Business Trip”) and an time stamp 504 that sets the time period for which the message asset is active (e.g., in this example, a 24-hour active time period has been set by an asset creator). Typically, the creator selects this time period, however, a default time period (e.g., six hours) may be assigned if a time period is not supplied by the creator. Setting this period, each recipient is able to respond to the message asset before the time expires. Along with blocking responses, once the time period expires, other operations may occur such as each instance of the message asset (present on any user device) being deleted. The interface 500 also includes a portion 504 that includes a text entry field that can be populated with characters, strings, etc. Various types of user input techniques may be implemented for entering information into the text field. While the interface 500 includes a graphical keypad 506 (presented on a touch sensitive display), other techniques such as employing a voice recognition system may be implemented for populating the text field.

In this particular example, the interface 500 also includes a portion 508 that presents additional data (e.g., interactive information) to be included in the message asset. Taking various forms (e.g., characters, graphics, etc.), this information supplements the text content of the message asset and can assist the creator and recipient(s) with information that complements the message based on its context. One or more techniques may be employed to identify such complementary information; for example, such information may be identified by analyzing the content of the text field. Such analysis operations may be executed by the device used to create the message (e.g., the smartphone 100), at a remote location (e.g., at the font service provider 312, the interactive data provider 332), executed in a distributed manner (e.g., by the smartphone and the font service provider 312), etc. To perform the analysis, operations such as filtering the message into segments and individually analyzing the segments, combinations of segments, etc. may be executed. For example, one or more predefined rules, relational databases, etc. may be employed to identify the context (or contexts) of the textual content and then determine additional information that would complement the content of the message asset. In this example, the textual content of the message asset relates to scheduling a business trip and polling the message recipients for an appropriate departure date. Through this analysis, this context of the message is identified and operations are then executed to identify possible departure dates. In one arrangement, relevant information is collected from one or more sources; for example, the font service provider 312 may access data (e.g., an electronic scheduling calendar) associated with the creator of the message and determine potential dates from various information (e.g., travel distance and locations, needed mode of travel, etc.). Such information can be accessed from one or more locations; for example, relevant information may be stored on the user device (e.g., the user's calendar stored on the smartphone 100), remotely located storage devices (e.g., the storage device 338 located that the interactive data provider 332), etc. As illustrated in the figures, six potential departure dates have been identified from the analysis and are presented in portion 508 of the interface. Along with determining potential departure dates other type of information may be identified from a contextual analysis of the created text message. Such contextual analysis of a message may be executed in a variety of manners; for example, the analysis may occur upon a previously created message (e.g., text message) or messages retrieved from storage.

With the analysis complete, and the potential dates identified and presented to the creator of the message, one or more operations may be executed. For example, the message creator can adjust the presented options prior to the message asset being sent out. Along with deleting, editing, etc., further options may be added to the option collection listed in interface portion 508. One or more recipients may be selected for including in the distribution of the message asset. Individuals, predefined groups of individuals, etc., may be selected by operations executed on the user device (smartphone 100), at the font service provider 312, etc. While this particular message asset includes one page for polling individuals to determine an appropriate departure date, message assets may also include multiple pages, e.g., to address other options.

Once the creator deems the message asset complete, the message (including the aggregate of text and interactive information) can be sent to each of the identified recipients for review and for selecting from the potential departure dates, in this example. Once received, one or more operations may be executed as the recipients select from the presented options. Generally, to make a selection, a recipient can interact with (e.g., press) the display portion presenting the option of interest (e.g., a particular date). Typically, only one option can be selected, however, in some instances multiple options may be selected (e.g., selecting a first choice, second choice, etc.). Once selected, a visual confirmation may be presented on the device display to ensure that the desired option has been selected. In situations in which an unwanted option has been inadvertently selected, the option can be deselected by a subsequent interaction with the interface portion presenting the option. In some instances, a recipient of the message asset may rather not select (or not be ready to select) one of the potential options (being presented) but make a suggestion. Or in other situations, the recipient may just want to provide a suggestion but not take part in the subject matter (e.g., event) described in the message asset. In such situations, the recipient can entry data (e.g., text), for example into the message asset, a reply message asset, etc. and send it to the creator of the original message asset. The creator can then decide whether to promote this suggestion (e.g., update the message asset to include another option, replace an option, etc.) and send an updated version of the message asset. In some arrangements, a suggestion of one recipient can be sent and viewed by other recipients (of the originally sent message asset) along with creator of the original message asset. Viewing the suggestion, the other recipients may send feedback information regarding the suggestion to the creator (and potentially the other recipients of the original message asset). For example, one or more of the other recipients may positively reflect on the recipient-provided suggestion and the creator may take this information into account (e.g., to update the options of the message asset).

Communications among the individuals associated with the message assets is secure and information is not shared (e.g., sent) with individuals not identified as being associated. One or more security techniques may be used to assure that message asset content is not provided to individuals not selected for receipt; for example, passwords, hashing, public/private key, and/or other types of security techniques may be employed. In some arrangements, each communication (e.g., the originally created message assets, reply messages, recipient suggestions, etc.) is secured prior to transmission. In some instances, received communications can be checked for being improperly accessed prior to being used to present content on a user device. If an improper access is detected, correction action may be triggered, such as further processing of the message asset to determine the nature of the accessing, the identity of the infiltrator, etc.

Messages assets such as the one illustrated in the figure can be configured to include a variety of different type of content. Along with textual content, which may be presented in a selected style (of a brand), graphics and imagery (e.g., photos, video, etc.) may be included. In some instances, such graphics, imagery, etc. may be provided by the creator of the message asset (e.g., photos, video, etc. are taken by the individual creating the message asset for inserting in the asset). Graphics, imagery, etc. may also be attained from other sources; for example, the creator of a message asset may retrieved from one or more sources such as device storage, provided or shared by other individuals, retrieved from various types of networked sources (e.g., social network services such as Facebook, Instagram, etc. from which photographs can be attained), etc. Audio content may also be included, for example, by attaching an audio file, a link (e.g., a uniform resource locator (URL)), etc. Such content may be used for providing options as determined by the message asset creator, such as attempting to identify the most appropriate departure date for attending an event. Additional content may also be included in the message asset and presented to the recipient; for example, upon selecting one presented option (e.g., a particular departure date), other options may be presented which may or may not depend upon the just-selected option. In some instances, actions related to the just-selected option can be executed on the user device; for example, a calendar marking may be entered into an electronic calendar to reserve the date for the event. Related actions can also include preparing for activities associated with the scheduled event. For example, a selectable graphic is presented for transportation details (e.g., airline tickets, automobile rental, etc.), arranging a pre-departure meal (e.g., making dinner reservations), attend to matters at the destination location (e.g., making hotel and rental car reservations). By providing such additional options, the recipients can be guided to many issues that should be addressed before the scheduled event. In some arrangements, such levels of options can be identified during the context analysis of the originally entered text (during message asset creation) and included in the message, for example, in a nested manner. Other types of materials may also be presented to each recipient; for example, local sites of interest can be identified from the destination included in the message (e.g., identified from the analysis) and related information presented to each user (e.g., notification of special events, potential savings such as electronic coupons, etc.).

While the message assets are highly configurable to provide a variety of content, particular configurations may be used over and over to the point of being considered a type of standard configuration. For such configurations, template data may be created and stored (e.g., at user devices, the font service provider, the interactive data provider, etc.) for relatively easy access. For example, the text messenger 200, the application 204, etc. being executed by the smartphone 100 may present different types of templates for selection by the user. Once selected, the application 204 may retrieve the template of interest from local storage (e.g., located on the smartphone) or from a remote storage location (e.g., at the font service provider, the interactive data provider, or other location accessible through the Internet 306). User created templates may also be stored locally, remotely, etc. for ease of retrieval by the creator of the template or other individuals. For example, one or more libraries of templates may be stored on a storage device (e.g., device 318, storage device 338, etc.) located that the font service provider 312, the interactive data provider 332, etc. Various techniques may be employed for accessing such libraries of templates, for example, rental periods, template purchase agreements, service agreements, etc. may be utilized to define template access conditions.

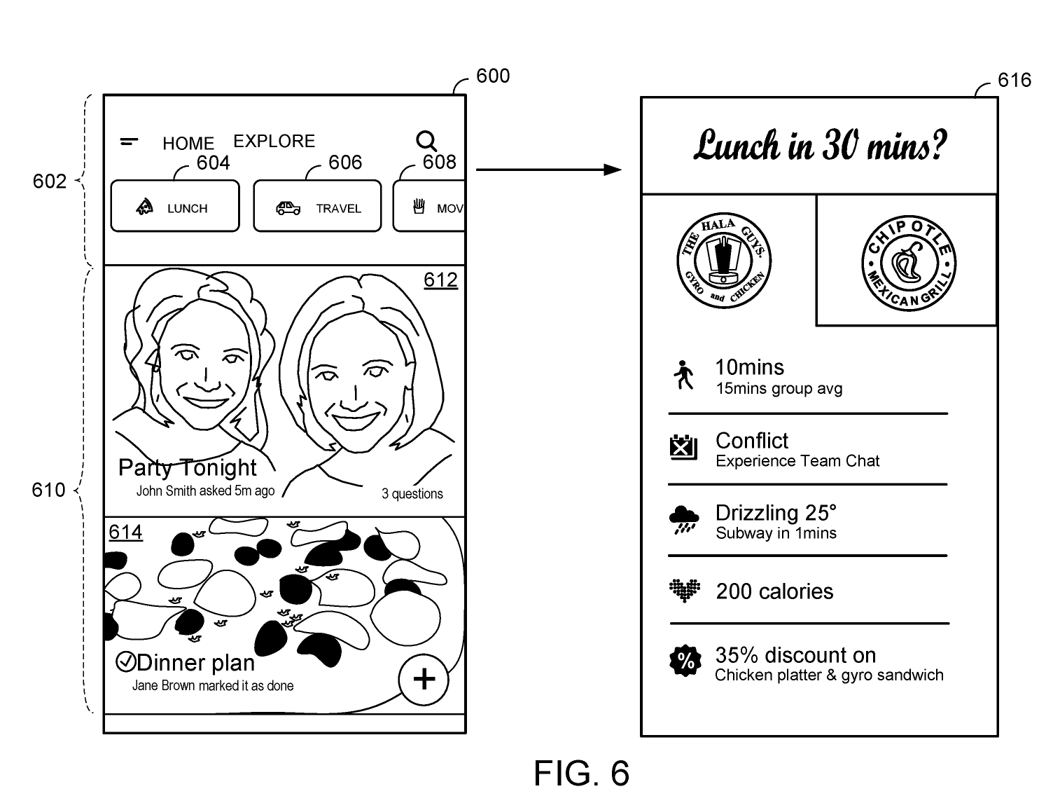

Referring to FIG. 6, a sequence of two images demonstrates the creation of a message asset from previous activities. An interface 600 presentable on a user device (e.g., the smartphone 100), is created by an executed application (e.g., text messenger 200, the application 204) and includes a portion 602 for creating a message asset for predefined activities (e.g., schedule a lunch 604, a trip 606, attending a movie 608). While portion 602 of the interface can be considered as being interactive for event planning, other portions of the interface can provide other functionality. For example, another portion 610 of the interface 600 presents a series of images associated with other message assets associated with the user (e.g., previously created message assets sent by the user, message assets received from another individual, etc.). Each of the images may be selected by the user (e.g., by touching the respective portion of a touch screen display) to display corresponding message assets. For example, selecting one image 612 can direct the user to a message asset for which requested information is still needed from the user (e.g., three questions need to be answered by the user). Also in portion 610 of the interface 600, another user-selectable image 614 is presented for directing the user to a message asset associated with a planned dinner that needs no further input from the user (e.g., as indicated by the event creator).

In this example, based upon the user-selection (to schedule a lunch 604) a message asset 616 is created and presented on the user device (e.g., smartphone 100) to assist with planning the lunch event. Options for the event are determined and presented on the message asset 616 based upon a variety of information that can be accessed by the executed application (e.g., text messenger 200, application 204). For example, previous message assets created by the user (some for similar events) may be accessed (e.g., from local device memory, from a service site such as the interactive data provider 332) to identify previous options selected by the user, event attendees, etc. Along with the previously generated message assets and related information (e.g., option selections), other type of data (e.g., historical data) may be employed. For example, user interaction with the executed application (e.g., selections made for other events) may be used. Historical data associated with other events may be processed and used; for example, the travel distance considered acceptable by the user for similar events, the mode of transportation employed by the user for such events, generally acceptable costs, etc. Historical data associated with others may also be utilized for developing options. For example, upon identifying potential attendees (e.g., the user selects other individuals, selects a predefined group, etc.), similar or different historical data may be retrieved (e.g., from local storage, remote storage, etc.). For example, travel distance for each potential attendee may be analyzed and used to identify possible options for the message asset 616. Other types of information may also be collected and analyzed; for example, weather conditions, types of faire, etc. Once one or more potential venues are identified, other information may be identified for inclusion in the message asset. For example, commerce related information (e.g., discounts, day-of-the-week specials, Internet accessible coupons, etc.) can be identified from a variety of sources (e.g., websites, previously collected data, attendee reviews, etc.). Upon performing the analysis and data collection, the relevant data may be aggregated and presented in the message asset 616. As illustrated in the example, two potential lunch locations have been identified and a selectable page is created for each and presented on the message asset 616.

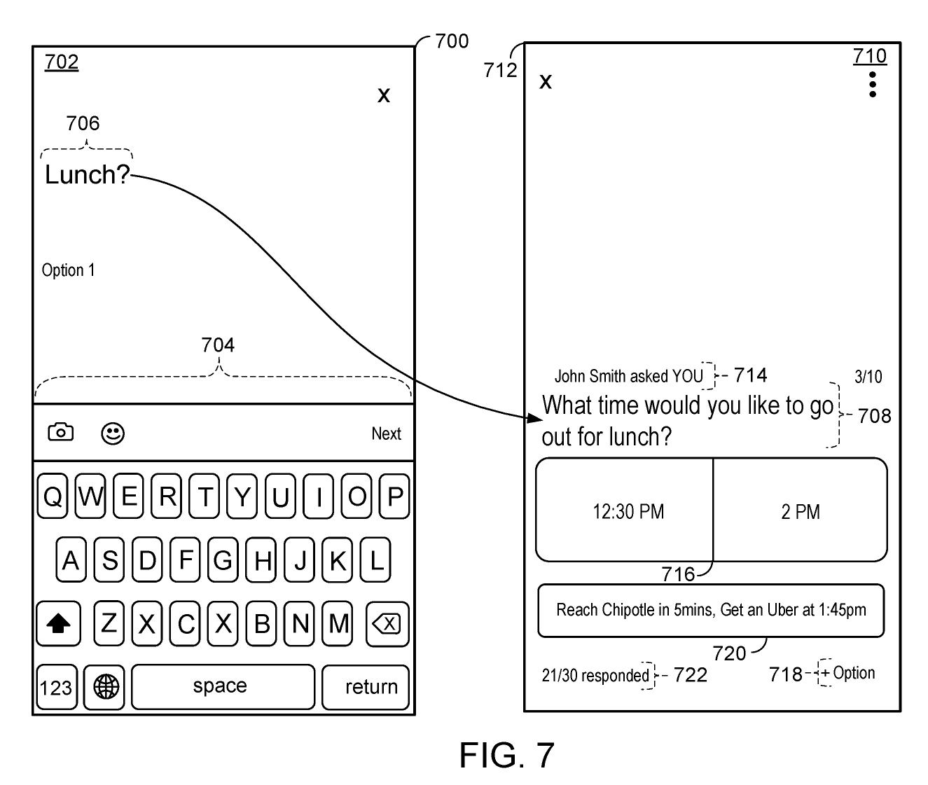

Referring to FIG. 7, in some arrangements, the context analysis of the text entered to create a message asset can trigger translation operations. For example, by processing abbreviated text (input by a message asset creator), a detailed message can be prepared in an automated manner. In this illustrated example, a relative short message “Lunch?” is analyzed to develop a more viewer-understandable phrase “What time would you like to go out for lunch?” Through this analysis, the message author can quickly assemble a message that can be processed (e.g., by the application 204, the text messenger 200, the interactive service manager 336, a combination of processes, etc.) and delivered to one or more recipients with more contextual detail. One or more techniques may be implemented for analyzing such messages and producing more contextually detailed messages for delivery. For example, natural language processing techniques may be employed that utilize machine learning processes (e.g., statistical machine learning) and statistical inference to develop rules by analyzing a considerable amount of text (e.g., a corpora of documents).

Such machine learning techniques operate on a large set of “features” generated from the input data. Some techniques use decision trees, rules (e.g., if-then rules) while other techniques such as more statistical based techniques implement statistical models capable of making soft, probabilistic decisions based on applying weights (e.g., real-valued weights) to input features. Rather than computing a single result, such statistical based techniques express relative certainty of multiple different results. Through learning techniques, most common cases are automatically focused upon and make use of statistical inference algorithms to produce models capable of addressing unfamiliar input (e.g. containing less familiar words, phrases, etc.), potentially erroneous inputs (e.g. containing misspelled words, inadvertently missing words), etc. In general, accuracy of such machine learning techniques can increase with being supplied more input data, increasing the number of rules, rule complexity, etc. Statistical natural-language processing generally uses stochastic, probabilistic, and statistical methods to resolve complexities that can arise, for example, from ambiguous words, phrases (e.g. long sentences), etc. Such natural language processing techniques include quantitative approaches to automated language processing, including probabilistic modeling, information theory, and linear algebra. Statistical natural language modeling generally comes from machine learning and data mining, both of which are fields of artificial intelligence that involve learning from data.

As illustrated in the figure, a user device 700 (e.g., a smartphone) includes an interface 702 that displays an interactive keyboard 704 for allowing the user to create a message asset. In this example, a relatively simple term 706 (i.e., “Lunch?”) is entered by the user to determine if one or more recipients would be interested going to lunch with the user (the creator of the message asset). Provided this term 706, natural language processing operations are executed to translate this one-word phrase into a more understandable context (e.g., a full sentence) for the recipient(s). In this example, the executed operations produce a sentence 708 that is presented on an interface 710 of a recipient user device 712. From a single term entered, a message asset may be created in an automated manner. Along with providing this expanded message, other information is included in the message asset, e.g., to assist with the recipient in efficiently answering the presented request of the message asset. As illustrated in the figure, a phrase 714 is included in the message asset that identifies the individual that created the message asset and that this individual has directed the question to the recipient. Additionally, a user-selectable graphic 716 allows the recipient to quickly realize what options (e.g., potential start times) are available for this event. One or more information sources may be used for identifying these options; for example, information stored at user devices (e.g., a smartphone), a remote service location such as a cloud-based service (e.g., the font service provider 312, the interactive data provider 332) such as a cloud-based Internet service, etc. In this example, two potential start times are determined from information associated with the creator of the message asset and the recipients. For example, respective calendars of the creator and the recipient (e.g., local electronic calendars stored on user devices, remote locations—such as cloud-based storage, etc.) may be checked. One or more techniques may be employed to arrive at such options; for example, comparisons of availability (via the calendars) may be used to arrive at the option times. Rules may be utilized, for example, to assist with determining availability; for example, a particular window may be defined (e.g., from 11:00 AM to 2:00 PM) for reasonable start times for the event. After review, the recipient can select either of the options provided by the graphic 716 and an indication of the selection is sent (e.g., to the interactive service provider, the creator's user device, to user devices of other recipients, etc.) for further processing. For example, the options may be compared to identify the most popular starting time, etc. Additionally in some arrangements the recipient may be allowed to suggest a time other than the options provided in the graphic 716. Such a suggestion can then be provided in a message to the asset creator (e.g., for adoption and re-circulation) and/or the other recipients (e.g., for feedback). In this example, a graphic 718 is presented on the message asset for adding another option and notifying the others.

Along with arriving at possible start times, other types of information may be determined and presented to recipients of the message asset, the creator, etc. For example, based upon historical data (e.g., location of previously attended events, travel distance, modes of transportation, etc.) complementary information can be determined and presented in the message asset (e.g., potential event location, transportation mode, etc.). In this illustrated example, a user selectable graphic 720 (e.g., a radio button) provides a suggested location (again based on historical data), transportation time, and a methodology for reaching the suggested location in an efficient manner. In this example, the message asset also provides other information that may be useful for the recipient, in particular, a graphic readout 722 presents both the number of individuals sent the message asset (e.g., that are members of a predefined group) along with the number of individuals that have responded. In some examples, upon selecting the graphic 722, identification of each recipient is presented along with an indication whether the recipient has sent a response.

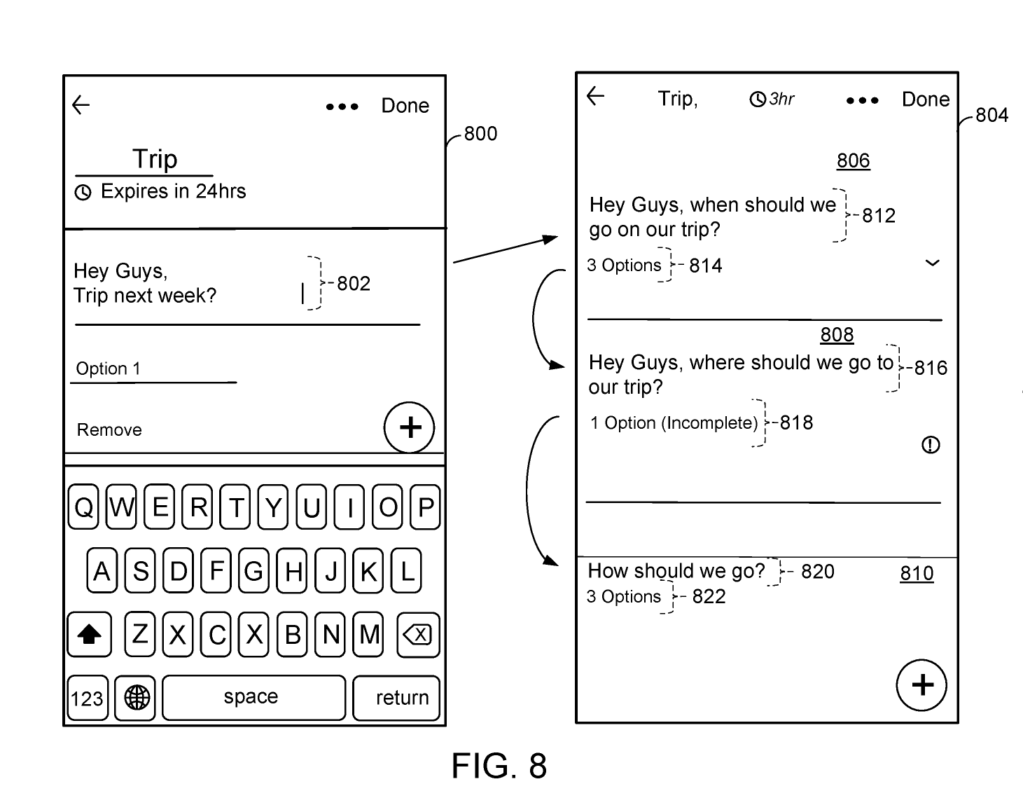

Referring to FIG. 8, a message asset may include multiple interactive segments to convey information to a viewer in a logical manner and to assist with collecting information from the viewer. For example, each of the multiple segments can include a question (and response options) related to the originally posed question of the message asset. By nesting the questions in a logical order, the viewer can independently focus on each question and select an appropriate response from presented options (or suggest other options). Efficiency can improve by logically stepping a viewer through various aspects (e.g., of an event) to be considered along with reducing potential confusion of the viewer (as options are selected). Illustrated in the figure, an interface 800 is employed by a device user (e.g., a smartphone user) to produce a message asset associated with planning a business trip. In this example, the user prepares a question 802 to initiate a trip for a group of individuals (that become recipients of the message asset). By processing the message (e.g., contextual analysis, natural language processing), the context of the message can be identified and a series of questions can be developed (along with possible options) for collecting responses from the potential attendees. For example, questions can be posed to each member of the recipient group regarding when to schedule the trip, where the destination of the trip, and the mode of transportation. As illustrated in the figure, an interface 804 of a one recipient device (a smartphone) presents three nested segments 806, 808, 810 of a message asset. The first segment 806 presents a question 812 regarding the timing of the business trip and options 814, the second segment 808 presents a question 816 regarding location of the trip and an option 818, and the third segment 808 that includes a question 820 regarding a mode of transportation and options 822 for the transportation choices. By stepping through these segments, options are selected by each of the recipients and can be processed (e.g., parameters for the trip can be determined based upon a majority vote of the option selections). The recipient selections can also be used with other message assets (e.g., stored as historical data for the recipient group, the individuals, etc.). In this particular example, the three segments are presented in a serial manner (e.g., segment 806 is followed by segment 808, which is followed by segment 810); however other presentation techniques may be employed. For example, multiple segments may be presented simultaneously, and then followed by individual or other sets of multiple segments. In one scenario, segments may be presented together to provide related questions for which it may be more appropriate to select from their options while viewing all of them.

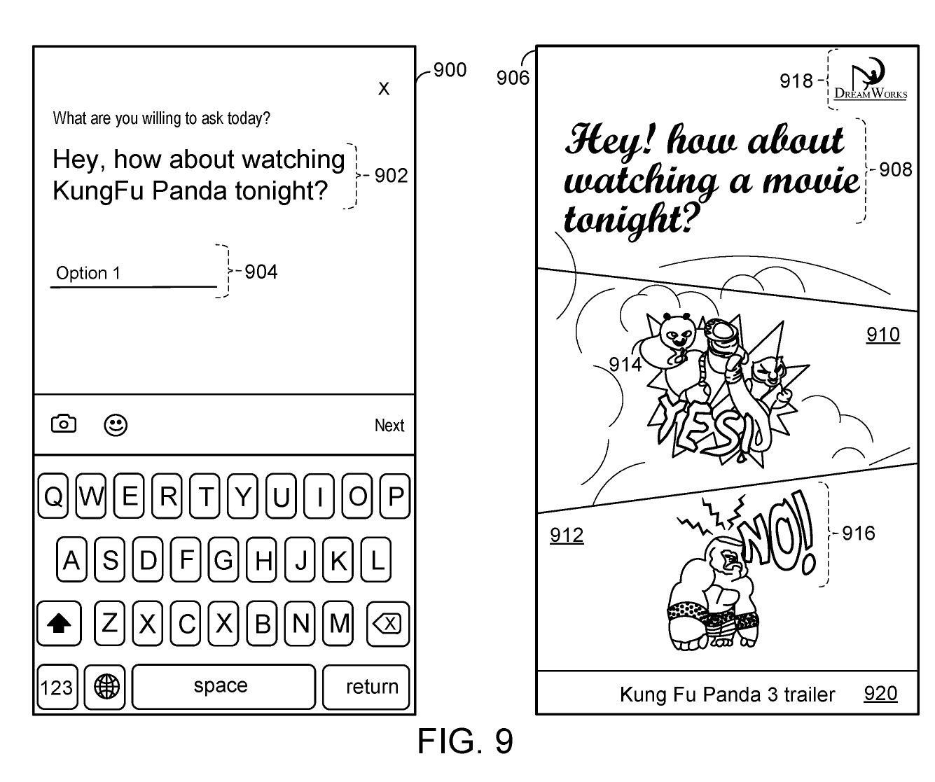

Referring to FIG. 9, additional content may be included in message assets, e.g., to provide additional information and context to its recipient(s). For example, stylistic information associated with a particular brand, entity, etc. such as a font, etc. may be incorporated. In this illustrated example, an interface 900 is presented on a user device and is used (e.g., via a displayed keyboard of a smartphone) to enter content for a message asset. A question 902 is entered that includes the name of a well-known motion picture, and a Boolean option 904 (e.g., “yes” or “no” response) is defined for each recipient to respond. From the text of the question 902, the motion picture is identified, for example, by processing the entered text (e.g., context based analysis, natural language processing, etc.) by one or more devices (e.g., through operations of the font service manager 312, the interactive data provider 332, the application 204 executed by the smartphone 100). Once identified, various types of additional processing operations may be executed for enhancing the content of the message asset. For example, message templates, background images, fonts, color schemes, graphical elements, etc. may be identified for applying to the message asset. In some arrangements, fonts associated with the motion picture, a promoter of the picture, the motion picture studio, etc., may be accessed from the font service provider 312 (e.g., via a link) and used to render the message asset. In this illustration, an interface 906 (e.g., of a smartphone) presents the created message asset and presents the question in a stylized font 908. Additionally, graphics from the motion picture are presented in two portions of the interface 906 to assist the recipient in responding to the question (as defined by the Boolean option 904). In this example, one portion 910 of the interface can be interacted with (e.g. touched by the viewer) to select one response (i.e., “Yes”) and another portion touched for 912 for selecting the other response (i.e., “No”). In this example, graphics of particular characters 914 of the motion picture are identified and used along with a particular font 916 associated with the motion picture (e.g., for labeling the two recipient-selectable options). Other types of stylized information may also be included for conveying particular information to the recipient; for example, a graphic 918 (e.g., logo) of the studio that produced the motion picture is presented. To complement the stylized graphics, other information may be provided such as selectable links 920 to content (e.g., trailers) associated with the motion picture. In this arrangement, these links 920 are identified and entered into the message asset in response to the motion picture being identified from the contextual analysis of the question 902.

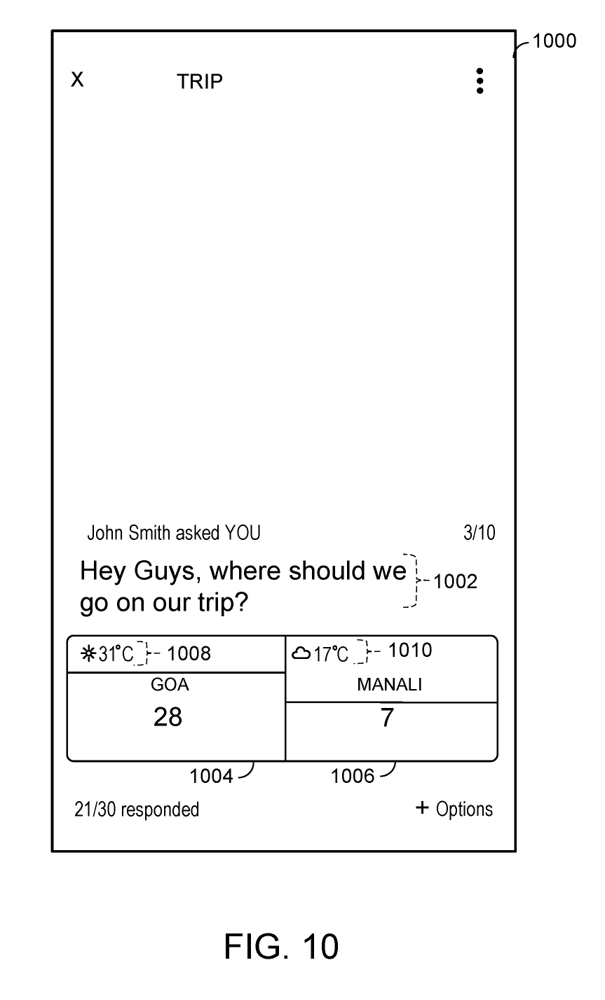

Referring to FIG. 10, along with providing content (e.g., text) defined by the creator of the message asset, information from a variety of sources may be integrated into a message asset, for example, information that complements message-creator selected content can be collected in an automated manner to enhance the viewing experience by presenting relevant data to the recipient. Such information may depend upon the creator's selected content to be viewed or may be independent of the content. In the illustrated example, data is collected that complements response options defined by the message creator. In particular, an interface 1000 presents text 1002 that poses a question to the recipients along with two response options 1004, 1006 that can be selected by each recipient. To assist with the recipient's selection of a possible destination, weather conditions of each potential location as are presented by icons 1008, 1010 (e.g., that represent the general conditions and current temperature). Projected or forecast weather data may also be provided in a similar manner as the illustrated current conditions. Other types of information may also be presented; for example, transportation data (e.g., current traffic and road conditions, etc.), accommodation information (e.g., hotel availability), etc. One or more techniques may be employed to attain such relevant information; for example, by parsing the content input by the message creator performing contextual analysis, information can be attained (e.g., the two potential travel locations) from which the complementary information can be collected (e.g., contact a weather information source and request the current conditions for the two identified locations).

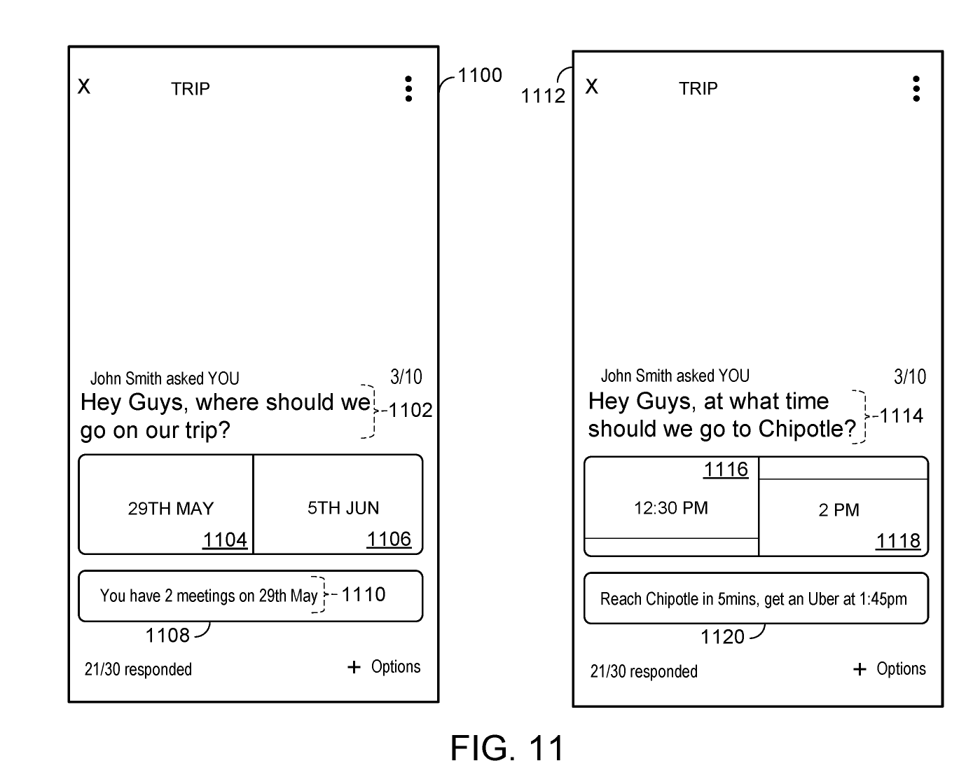

Referring to FIG. 11, complementary data from sources besides the creator of a message asset may be associated with message recipients (e.g., individual recipients, groups of recipients, etc.). For example, an interface 1100 shows a message asset that has been created to solicit each recipient to select a potential date for a business trip (e.g., as posed by the textual question 1102). Additionally, two options are presented in selectable graphics 1104, 1106 that respectively provide information about the options (e.g., potential travel dates). Provided this information, operations may be executed (e.g., locally by the recipient's user device, remotely at the font service provider, the interactive data provider, etc.) to determine if the recipient is clear to select either option or if there is a potential conflict. For example, the message asset provided to the recipient may be parsed to identify each proposed travel date and then check with calendar information associated with the recipient. In the illustrated scenario, a potential conflict is detected and a graphic 1108 is presented to the message recipient on the interface 1100. In this particular example, the details are presented with the graphic 1108 as a string of text 1110 to alert the recipient to the potential conflicts. Other techniques may also be employed for notification; for example, the graphic 1108 may be user-selectable for presenting a calendar representation (and highlight any potential conflicts). Similar to checking one or more dates, particular times (e.g., event start time, time periods, etc.) associated with selectable options or other types of information may be checked. Further, other types of content may be used to notify a user; for example, other types of visual cues (e.g., particular colors, video, etc.), audio cues (e.g., pre-recorded messages, etc.), combinations of cues, etc. may be employed. Complementary information may be determined and presented based upon a selection being made by a recipient. For example, after one option has been selected, other actions may be presented (for selection) and calendared to assist with the initial option selection. In the illustrated example, an interface 1112 is presented on a recipient's device (e.g., smartphone) that includes a message 1114 prompting the recipient to select from two options (presented in graphics 1116, 1118) to schedule a lunch time at a particular location. Again, from the recipient's perspective, operations are executed (e.g., by the user device, at a remote location, in a distributed manner using multiple devices, etc.) to investigate the content of the message for making further determinations. For example, the lunch location can be determined from parsing the content of the text message 1114. Armed with this information, further identifying information (e.g., location address, appropriate route, mode of transportation, etc.) can be determined. Historical information may also be access to assist with determinations; for example, calendars and other types of records can be checked to determine if this location has been previously selected (for a similar event) and complementary information identified (e.g., previous travel routes, previously used mode of transportation, etc.). Once determined, this information can be presented to the recipient. In this example, a graphic 1120 is presented to provide the complementary information that includes text that provides a suggested mode of transportation and related information. In this instance both historical information (e.g., the mode of transportation, departure time, etc.) and current information (e.g., travel time to reach destination) are provided. To act upon the presented information (e.g., schedule transport to the lunch), the user selects that graphic 1120 and is directed to an appropriate data location (e.g., a website, webpage, etc.) for further operations (e.g., confirm transportation, etc.). Along with improving efficiency for determining what event parameters work best for a recipient, such complementary information can also flag potential issues for recipients.

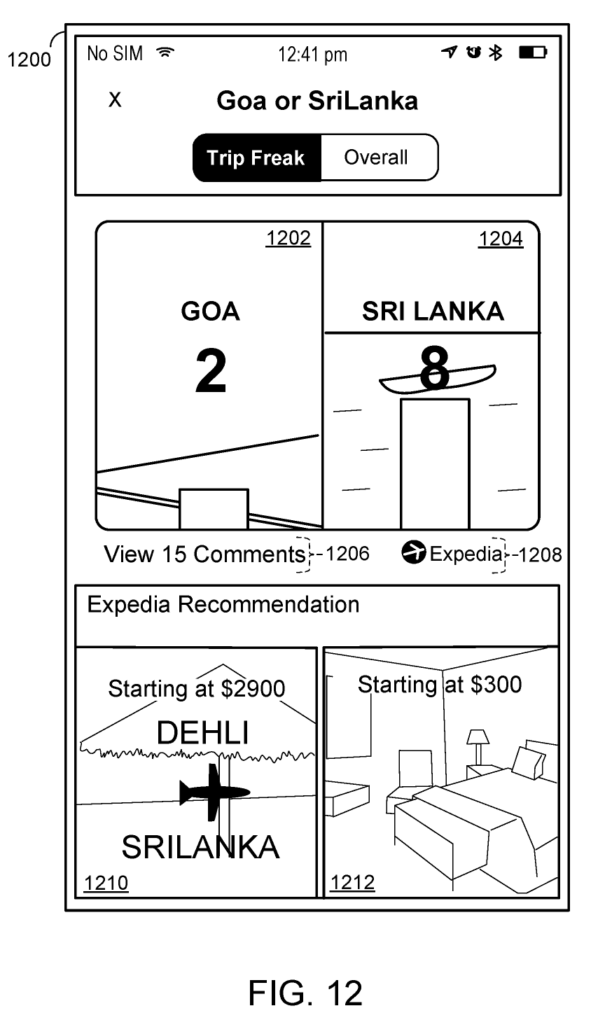

Referring to FIG. 12, such complementing information may also assist by directing the recipient to particular e-commerce activities which may be directly related (or indirectly related) to the event being planned. In this example, an interface 1200 presents two travel options (e.g., vacation destinations) in two respective graphics 1202, 1204. Along with providing graphical content associated with each destination, each graphic 1202, 1204 also includes a current selection count for each (e.g., 2 selections for Goa and 8 selections for Sri Lanka). Such count information, along with comments 1206 (e.g., provided from message recipients) can assist undecided recipients with their selection. Recipients can also be directed to other information sources, for assisting with planning for the presented event; for example, one or more links (e.g., uniform resource identifiers—URLs) to such resources may be presented. In this illustrated example, a selectable graphic 1208 provides a path to a travel website to provide travel assistance (e.g., schedule flights, car rentals, etc.) for the planned event. Along with logos, trademarks, etc. associated with such travel entities, stylized fonts that employ graphical features (e.g., colors, shapes, etc.) may also be used for attracting a viewer's attention (e.g., to use a service). Additionally, information from one or more of such services may be independently presented in the interface 1200 for quick assessment by the recipient. For example, scheduling, price, etc. information may be presented for option selection and event planning. In this illustration, two graphics 1210, 1212 provide flight pricing and hotel room pricing that may assist the viewer in selecting one of the two options presented. In some instances, such independent recommendations may be associated with special offers, packages, etc. of a travel entity, for example, for particular periods of time (e.g., during holiday seasons).

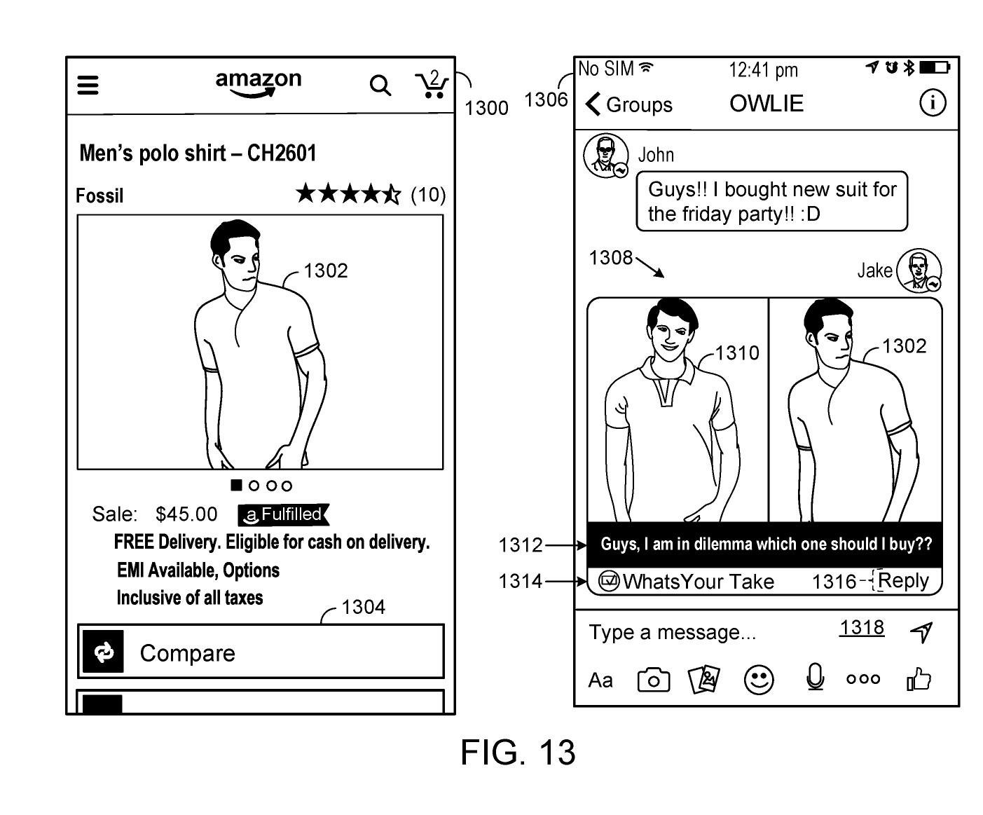

Referring to FIG. 13, other types of activities may be assisted through the creation of such messages that solicit input from recipients by presenting polling opportunities. For example, e-commerce activities could be enhanced by polling individuals about purchases, rentals, etc. In this illustrated example, a message asset is created to poll recipients for input about purchasing a garment being advertised by an internet purchase site. After reviewing (in an interface 1300) the garment 1302 and becoming interested, the potential purchaser can select a graphic 1304 to initiate operations for comparing this garment with others. The potential purchaser could review the various options and decide which item (or items) to purchase. In this example, a message asset can be created to solicit input. On the recipient side, an interface 1306 (on the recipient's device) presents a message asset 1308 that includes two graphics, each showing one of the two garments 1302 and 1310 of interest. The message asset also includes a string of text 1312 drafted by the creator of the message asset (e.g., to provide context about the purchase for the recipient), and, includes a graphic 1314 that is selectable by the recipient to provide input. In some arrangements, the recipient may simply select one or both of the presented items (e.g., by pressing the corresponding portion of the interface) and then press a graphic 1316 for replying to the creator of the message asset. Other types of feedback techniques may be employed; for example, a text message, an audio recording, etc. may be created by the recipient and which may be initiated by selecting an appropriate icon from a lower portion 1318 of the interface 1306. Provided feedback from the recipients, the creator of the message asset can then use this information to make a purchase decision, request additional feedback from the recipients, request input from other individuals (e.g., increase the number of recipients of the message asset, etc.). In this particular example, each item of clothing is presented in imagery generated for sell the respective item (e.g., each shirt is presented in a professionally produced photograph). However, in some arrangements, user generated imagery, graphics, etc. may be included in the message asset for presenting the items to recipients. For example, the potential purchaser may take a photograph of each item for including in the message asset for side-by-side comparison (e.g., replace the graphics 1302 and 1310 in the message asset 1308 with the purchaser taken photographs). In some instances, viewers may be more receptive to less “staged” imagery for comparing products, making purchase decisions, etc.

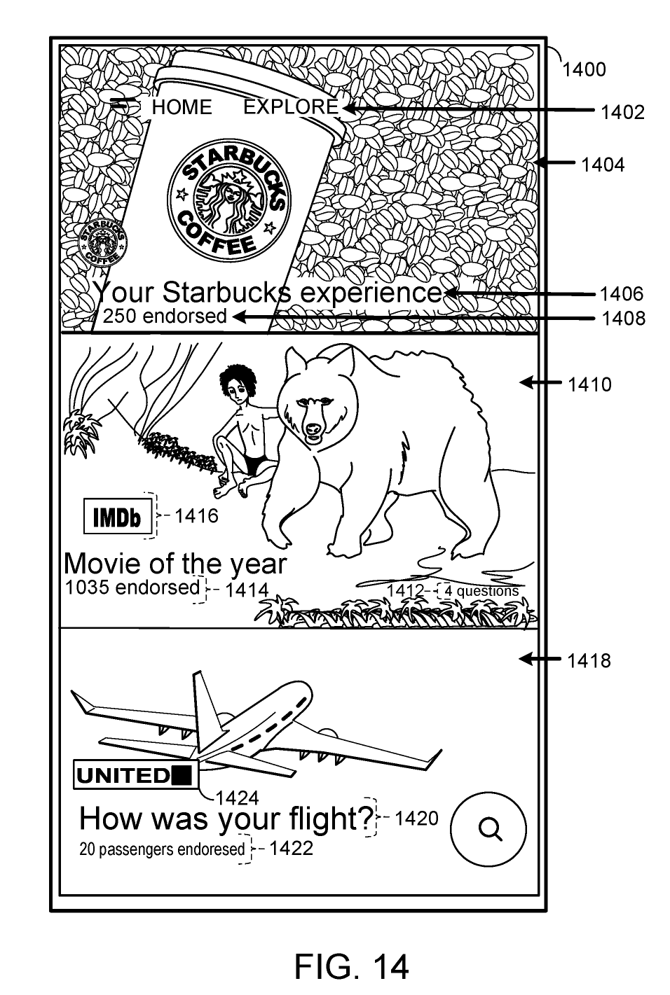

Referring to FIG. 14, message assets may be developed for delivery to the general public, thereby allowing more individuals to provide feedback based upon presented questions (e.g., queries, polling questions), selectable responses, etc. In some arrangements, one or more conditions may be applied for identifying recipients from the general public (e.g., identify a particular group); however, in other arrangements, no conditions may be applied and any member of the general public may be a considered a recipient (of the message asset) and provide feedback. Regarding applied conditions, some conditions may be based upon user activities with an entity associated with the message asset. For example, if an individual recently purchased a product, used a service, etc. of the associated entity (e.g., a company, industry, etc.) then one or more message assets could be directed to the user (e.g., delivered, access granted, etc.). Referring briefly back to FIG. 3, interactions with a style owner (e.g., a brand owner), a publisher, etc. can trigger a message asset being delivered. Returning to FIG. 14, an interface 1400 is presented that includes a listing of the asset messages delivered to and viewed by a recipient device user. In this example, access to the listing, which may be locally stored (on the user device), remotely stored (e.g., at the font service provider 312), etc., is presented upon the recipient selecting a textual graphic 1402 (labeled “Explore”). In the current view, three separate message assets are presented, each being associated with a different style/brand owner. For example, message asset 1404 may be provided to a user (e.g., delivered, granted access to, etc.) upon purchasing a product (e.g., a hot beverage) from the identified company. Once presented, the recipient can select a link (e.g., presented as a text string 1406) that directs the recipient to information regarding the style/brand owner (e.g., via one or more URL's, etc.). For example, one or a series of polling questions may be presented for recipient feedback (e.g., to endorse the brand, purchasing experience, etc.). Once received, one or more graphics (e.g., a numerical value 1408 representing endorsements) may be adjusted to reflect the feedback.

Similar to using purchased goods and services as a trigger event for being provided a message asset (developed for the general public), other information associated with individuals may be used. For example, historical data associated with an individual (e.g., click data, types of websites visited or interacted with, etc.) may be used to warrant delivery of a message asset. As illustrated in the figure, historical data may reflect a particular interest of an individual and a message asset may be prepared for delivery (e.g., a predefined message asset template may be used to create the message asset). In this instance, upon being identified as having a strong interest in motion pictures (e.g., through click data, website viewing habits, etc.), a message asset 1410 is presented that provides access to polling questions (and response options), for example. To provide feedback, a text string 1412 (labeled “4 questions”) can be selected by the recipient. Based upon the feedback provided, information being presented on the message asset can be updated; for example, a graphical representation of the currently most popular motion picture (e.g., a representation of a scene from the motion picture) is presented along with a numerical count 1414 of the current motion picture leading the polls. Similar to the message asset above 1404, a graphical representation of a brand (e.g., a logo 1416) may also be presented that is related to the created message asset, etc. Presented in the lowest position of the listing, another message asset 1418 similarly requests for user feedback regarding a service recently experienced by the recipient. The feedback can be provided upon selecting a text string 1420 and an endorsement count 1422 is updated, for example, for each instance that feedback is provided. To promote the brand of this business entity (an airline, in this example), a logo 1424 including a stylized font associated with the brand and a graphical representation of the service provided in also included in the message asset.

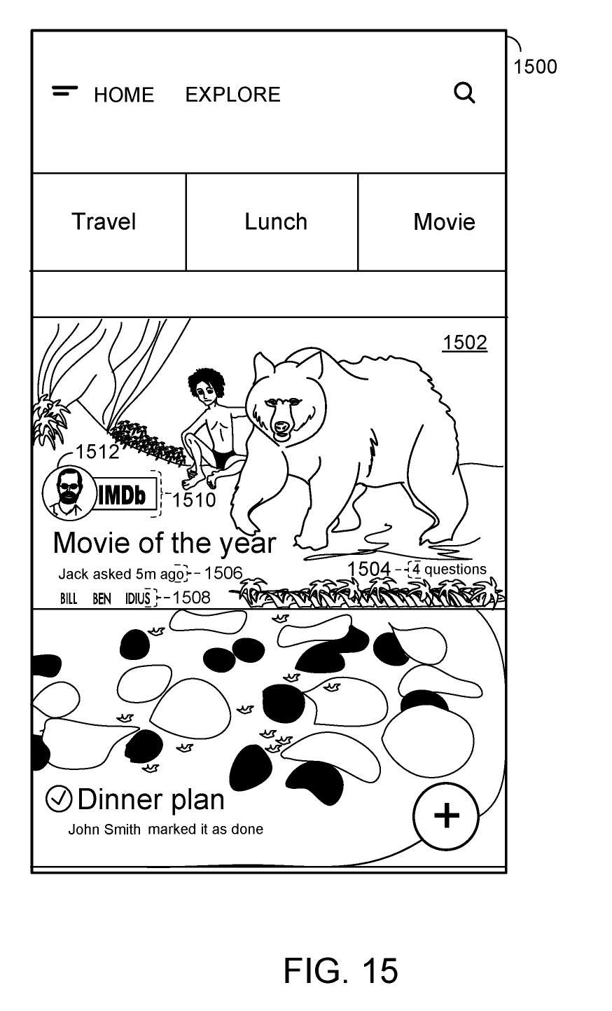

Referring to FIG. 15, publically available message assets may be distributed in one or more manners. Beyond being accessible be the general public, the message assets may be shared among individuals. For example, noticed by one individual, a message asset may be provided to another (in effect “shared” with another individual). In one system arrangement, a private communication from individual to another initiates the sharing of the message asset. Due to this individual-to-individual message asset transfer, the shared message asset may be presented in another portion of a user interface. For example, publically available message assets (received by a user) may be entered and viewed in one series, and, more private message assets (e.g., sent from one user to another user, shared among members of a group, etc.) may be viewed in another series. In this illustrated example, an interface 1500 that presents a series of private message assets (rather than publically available message assets). One message asset 1502 included in the series was originally created for being assessable by the general public (e.g., message asset 1410 shown in FIG. 14); however, in this instance the message asset has been provided by another individual (e.g., shared by a fellow group member, etc.). Similar to the publically available version of the message asset, a text string 1504 (labeled “4 questions”) is user-selectable (e.g., functions as a radio button) and directs the viewer to questions (e.g., four questions) regarding the topic of the message asset (e.g., motion pictures). Along with identifying the individual 1506 (e.g., group member) that provided the message asset 1502, text 1508 (included in the message asset) identifies other group members that have similarly been provided a private version of the message asset and asked to provide feedback. Similar to the message assets of FIG. 14, a graphical representation of the brand (e.g., a logo 1510) is included that identifies the brand and has a stylized font that is associated with the brand. Additionally, a graphic 1512 is included in the message asset 1502 that indicates a relationship between an individual and the brand (of the logo 1510). For example, the individual (e.g., the sender of this message asset) has become affiliated with the brand, e.g., can use stylized graphical information associated with the brand. In some arrangements the individual can use this stylized information (e.g., stylized font associated with the brand) for sending messages etc., thereby promoting the brand to other individuals (e.g., other group members, the general public, etc.).

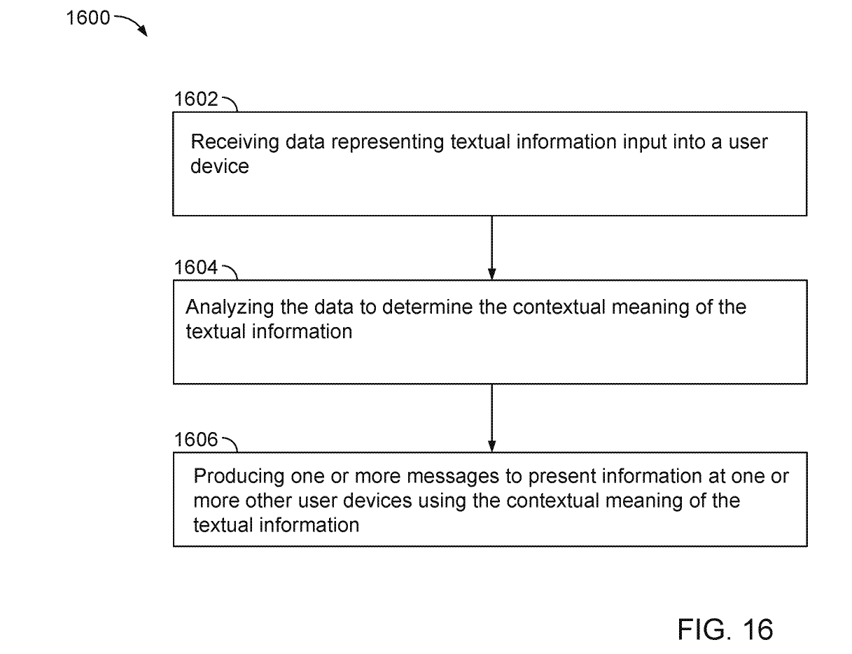

Referring to FIG. 16, a flowchart 1600 represents operations of a text messenger (e.g., the text messenger 200 shown in FIG. 2) being executed by a computing device (e.g., smartphone 100 also shown in FIG. 2). Operations of the text messenger are typically executed by a single computing device; however, operations may be executed by multiple computing devices in some arrangements. Along with being executed at a single site (e.g., the location of an end user), the execution of operations may be distributed among two or more locations. For example, execution of operations may be distributed among user devices, the font service provider 312 (also shown in FIG. 3), the interactive data provider 332, and/or other entities of a networked environment (e.g., environment 300 also shown in FIG. 3).

Operations of the text messenger may include receiving 1602, receiving data representing textual information input into a user device. For example, a user interested in sending information to one or more recipients can enter a textual phrase (e.g., the phrase “Lunch?”) into a user device such as a smartphone. Operations may also include analyzing 1604 the data to determine the contextual meaning of the textual information. For example, the entered phrase (e.g., “Lunch”) may be processed to identify related information (e.g., using previously prepared messages, preferences of the user such as locations and times of interest, previous interactions with potential recipients, etc.) that provide context (e.g., translates the phrase “Lunch” into “What time would you like to go out for lunch?”). Operations may also include producing 1606 one or more messages to present information at one or more other user devices using the contextual meaning of the textual information. For example, an expanded message (e.g., “What time would you like to go out for lunch?”) may be provided to one or more individually that may be interested in sending a response to the message creator and attending the lunch event. Along with efficiently providing information with enough detail to be understandable by the recipients, additional information (e.g., potential locations, modes of transportation, etc.) can be determined from the contextual information and provided. By identifying this information in an automatic manner, messages can be sent from one individual to one or multiple others without a substantial amount of time and focus needed from the message creator. Additionally by adding queries, polls, etc. to the delivered message (based upon the contextual information), responses such as feedback and input from others can be efficiently and effectively collected without excessively exchanging messages.

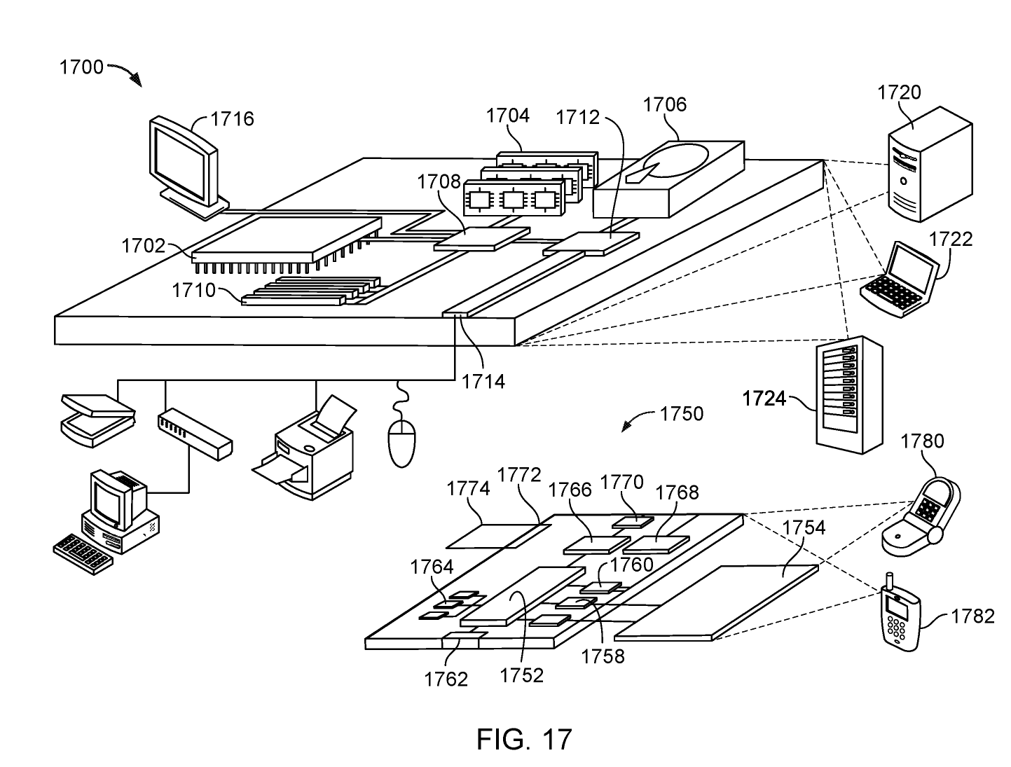

FIG. 17 shows an example of example computer device 1700 and example mobile computer device 1750, which can be used to implement the techniques described herein. For example, a portion or all of the operations of the text messenger 200 (shown in FIG. 2) may be executed by the computer device 1700 and/or the mobile computer device 1750. Computing device 1700 is intended to represent various forms of digital computers, including, e.g., laptops, desktops, workstations, personal digital assistants, servers, blade servers, mainframes, and other appropriate computers. Computing device 1750 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 1700 includes processor 1702, memory 1704, storage device 1706, high-speed interface 1708 connecting to memory 1704 and high-speed expansion ports 1710, and low speed interface 1712 connecting to low speed bus 1714 and storage device 1706. Each of components 1702, 1704, 1706, 1708, 1710, and 1712, are interconnected using various busses, and can be mounted on a common motherboard or in other manners as appropriate. Processor 1702 can process instructions for execution within computing device 1700, including instructions stored in memory 1704 or on storage device 1706 to display graphical data for a GUI on an external input/output device, including, e.g., display 1716 coupled to high speed interface 1708. In other implementations, multiple processors and/or multiple busses can be used, as appropriate, along with multiple memories and types of memory. Also, multiple computing devices 1700 can be connected, with each device providing portions of the necessary operations (e.g., as a server bank, a group of blade servers, or a multi-processor system).

Memory 1704 stores data within computing device 2000. In one implementation, memory 1704 is a volatile memory unit or units. In another implementation, memory 1704 is a non-volatile memory unit or units. Memory 1704 also can be another form of computer-readable medium (e.g., a magnetic or optical disk. Memory 1704 may be non-transitory.)

Storage device 1706 is capable of providing mass storage for computing device 1700. In one implementation, storage device 1706 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer- or machine-readable medium, (e.g., memory 1704, storage device 1706, memory on processor 1702, and the like.)

High-speed controller 1708 manages bandwidth-intensive operations for computing device 1700, while low speed controller 1712 manages lower bandwidth-intensive operations. Such allocation of functions is an example only. In one implementation, high-speed controller 1708 is coupled to memory 1704, display 1716 (e.g., through a graphics processor or accelerator), and to high-speed expansion ports 1710, which can accept various expansion cards (not shown). In the implementation, low-speed controller 1712 is coupled to storage device 1706 and low-speed expansion port 1714. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing device 1700 can be implemented in a number of different forms, as shown in the figure. For example, it can be implemented as standard server 1720, or multiple times in a group of such servers. It also can be implemented as part of rack server system 1724. In addition or as an alternative, it can be implemented in a personal computer (e.g., laptop computer 1722.) In some examples, components from computing device 1700 can be combined with other components in a mobile device (not shown), e.g., device 1750. Each of such devices can contain one or more of computing device 1700, 1750, and an entire system can be made up of multiple computing devices 1700, 1750 communicating with each other.

Computing device 1750 includes processor 1752, memory 1764, an input/output device (e.g., display 1754, communication interface 1766, and transceiver 1768) among other components. Device 1750 also can be provided with a storage device, (e.g., a microdrive or other device) to provide additional storage. Each of components 1750, 1752, 1764, 1754, 1766, and 1768, are interconnected using various buses, and several of the components can be mounted on a common motherboard or in other manners as appropriate.

Processor 1752 can execute instructions within computing device 1750, including instructions stored in memory 1764. The processor can be implemented as a chipset of chips that include separate and multiple analog and digital processors. The processor can provide, for example, for coordination of the other components of device 1750, e.g., control of user interfaces, applications run by device 1750, and wireless communication by device 1750.

Processor 1752 can communicate with a user through control interface 1758 and display interface 1756 coupled to display 1754. Display 1754 can be, for example, a TFT LCD (Thin-Film-Transistor Liquid Crystal Display) or an OLED (Organic Light Emitting Diode) display, or other appropriate display technology. Display interface 1756 can comprise appropriate circuitry for driving display 1754 to present graphical and other data to a user. Control interface 1758 can receive commands from a user and convert them for submission to processor 1752. In addition, external interface 1762 can communicate with processor 1742, so as to enable near area communication of device 1750 with other devices. External interface 1762 can provide, for example, for wired communication in some implementations, or for wireless communication in other implementations, and multiple interfaces also can be used.

Memory 1764 stores data within computing device 1750. Memory 1764 can be implemented as one or more of a computer-readable medium or media, a volatile memory unit or units, or a non-volatile memory unit or units. Expansion memory 1774 also can be provided and connected to device 1750 through expansion interface 1772, which can include, for example, a SIMM (Single In Line Memory Module) card interface. Such expansion memory 1774 can provide extra storage space for device 1750, or also can store applications or other data for device 1750. Specifically, expansion memory 1774 can include instructions to carry out or supplement the processes described above, and can include secure data also. Thus, for example, expansion memory 1774 can be provided as a security module for device 1750, and can be programmed with instructions that permit secure use of device 1750. In addition, secure applications can be provided through the SIMM cards, along with additional data, (e.g., placing identifying data on the SIMM card in a non-hackable manner.)

The memory can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory 1764, expansion memory 1774, and/or memory on processor 1752), which can be received, for example, over transceiver 1768 or external interface 1762.

Device 1750 can communicate wirelessly through communication interface 1766, which can include digital signal processing circuitry where necessary. Communication interface 1766 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 1768. In addition, short-range communication can occur, e.g., using a Bluetooth®, WiFi, or other such transceiver (not shown). In addition, GPS (Global Positioning System) receiver module 1770 can provide additional navigation- and location-related wireless data to device 1750, which can be used as appropriate by applications running on device 1750. Sensors and modules such as cameras, microphones, compasses, accelerators (for orientation sensing), etc. may be included in the device.

Device 1750 also can communicate audibly using audio codec 1760, which can receive spoken data from a user and convert it to usable digital data. Audio codec 1760 can likewise generate audible sound for a user, (e.g., through a speaker in a handset of device 1750.) Such sound can include sound from voice telephone calls, can include recorded sound (e.g., voice messages, music files, and the like) and also can include sound generated by applications operating on device 1750.

Computing device 1750 can be implemented in a number of different forms, as shown in the figure. For example, it can be implemented as cellular telephone 1780. It also can be implemented as part of smartphone 1782, a personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computing device implemented method comprising:
receiving data representing textual information input into a user device;
analyzing the data to determine the contextual meaning of the textual information; and
producing one or more messages to present information at one or more other user devices using the contextual meaning of the textual information.

2. The computing device implemented method of claim 1, wherein analyzing the data to determine the contextual meaning of the textual information includes determining one or more input requesting queries for including in the one or more messages.

3. The computing device implemented method of claim 2, wherein the input requesting queries includes one or more poll questions.

4. The computing device implemented method of claim 3, wherein the produced one or more messages presents the poll questions in a nested manner.

5. The computing device implemented method of claim 2, further comprising:
receiving feedback information from the one or more other user devices in response to the input requesting queries.

6. The computing device implemented method of claim 1, wherein analyzing the data to determine the contextual meaning of the textual information includes using historical data associated with producing previous messages.

7. The computing device implemented method of claim 1, wherein analyzing the data to determine the contextual meaning of the textual information includes performing a natural language processing.

8. The computing device implemented method of claim 1, wherein producing one or more messages to present information at one or more other user devices using the contextual meaning of the textual information includes identifying one or more graphics for including in the one or more messages.

9. The computing device implemented method of claim 1, wherein producing one or more messages to present information at one or more other user devices using the contextual meaning of the textual information includes identifying links for including in the one or more messages.

10. The computing device implemented method of claim 1, wherein analyzing the data to determine the contextual meaning of the textual information includes identifying information that complements the contextual meaning of the textual information.

11. The computing device implemented method of claim 10, wherein complementary information includes event related information.

12. The computing device implemented method of claim 10, wherein complementary information includes graphics associated with the contextual meaning of the textual information.

13. A system comprising:
a computing device comprising:
a memory configured to store instructions; and
a processor to execute the instructions to perform operations comprising:
receiving data representing textual information input into a user device;
analyzing the data to determine the contextual meaning of the textual information; and
producing one or more messages to present information at one or more other user devices using the contextual meaning of the textual information.

14. The system of claim 13, wherein analyzing the data to determine the contextual meaning of the textual information includes determining one or more input requesting queries for including in the one or more messages.

15. The system of claim 14, wherein the input requesting queries includes one or more poll questions.

16. The system of claim 15, wherein the produced one or more messages presents the poll questions in a nested manner.

17. The system of claim 14, the operations further comprising:
receiving feedback information from the one or more other user devices in response to the input requesting queries.

18. The system of claim 13, wherein analyzing the data to determine the contextual meaning of the textual information includes using historical data associated with producing previous messages.

19. The system of claim 13, wherein analyzing the data to determine the contextual meaning of the textual information includes performing a natural language processing.

20. The system of claim 13, wherein producing one or more messages to present information at one or more other user devices using the contextual meaning of the textual information includes identifying one or more graphics for including in the one or more messages.

21. The system of claim 13, wherein producing one or more messages to present information at one or more other user devices using the contextual meaning of the textual information includes identifying links for including in the one or more messages.

22. The system of claim 13, wherein analyzing the data to determine the contextual meaning of the textual information includes identifying information that complements the contextual meaning of the textual information.

23. The system of claim 22, wherein complementary information includes event related information.

24. The system of claim 22, wherein complementary information includes graphics associated with the contextual meaning of the textual information.

25. One or more computer readable media storing instructions that are executable by a processing device, and upon such execution cause the processing device to perform operations comprising:
receiving data representing textual information input into a user device;
analyzing the data to determine the contextual meaning of the textual information; and
producing one or more messages to present information at one or more other user devices using the contextual meaning of the textual information.

26. The computer readable media of claim 25, wherein analyzing the data to determine the contextual meaning of the textual information includes determining one or more input requesting queries for including in the one or more messages.

27. The computer readable media of claim 26, wherein the input requesting queries includes one or more poll questions.

28. The computer readable media of claim 27, wherein the produced one or more messages presents the poll questions in a nested manner.

29. The computer readable media of claim 26, the operations further comprising:
receiving feedback information from the one or more other user devices in response to the input requesting queries.

30. The computer readable media of claim 25, wherein analyzing the data to determine the contextual meaning of the textual information includes using historical data associated with producing previous messages.

31. The computer readable media of claim 25, wherein analyzing the data to determine the contextual meaning of the textual information includes performing a natural language processing.

32. The computer readable media of claim 25, wherein producing one or more messages to present information at one or more other user devices using the contextual meaning of the textual information includes identifying one or more graphics for including in the one or more messages.

33. The computer readable media of claim 25, wherein producing one or more messages to present information at one or more other user devices using the contextual meaning of the textual information includes identifying links for including in the one or more messages.

34. The computer readable media of claim 25, wherein analyzing the data to determine the contextual meaning of the textual information includes identifying information that complements the contextual meaning of the textual information.

35. The computer readable media of claim 34, wherein complementary information includes event related information.

36. The computer readable media of claim 34, wherein complementary information includes graphics associated with the contextual meaning of the textual information.
